(19) United States
(12) Patent Application Publication
(10) Pub. No.: US 2025/0148142 A1
(43) Pub. Date: May 8, 2025

(54) METHOD FOR CALCULATING OPENING RESPONSE OF SHIELD TUNNEL WITH SUPPORTS

(71) Applicants: ZHEJIANG UNIVERSITY, Hangzhou (CN); Power China Huadong Engineering Corporation Limited, Hangzhou (CN)

(72) Inventors: Zhongxuan YANG, Hangzhou (CN); Zhangpeng CHEN, Hangzhou (CN); Jiajia YAN, Hangzhou (CN); Rongqiao XU, Hangzhou (CN); Xiaonan GONG, Hangzhou (CN); Jinchang WANG, Hangzhou (CN)

(21) Appl. No.: 18/884,150

(22) Filed: Sep. 13, 2024

(30) Foreign Application Priority Data
Oct. 26, 2023 (CN) 202311400316.5

(51) Int. Cl. G06F 30/13

(52) U.S. Cl. CPC G06F 30/13

(57) ABSTRACT

A method for calculating an opening response of a shield tunnel with supports. A rectangular opening is formed in the shield tunnel, and the supports is arranged in the shield tunnel. Calculating a segment response of the tunnel after opening comprises: dividing segments into sections along the longitudinal seam to obtain transfer equations within and between sections, with internal forces at the opening being 0; simulating, by Timoshenko curved beam and straight beam theory, segments and supports; simulating, by radial, tangential and rotating three-directional springs, longitudinal joints, and simulating, by two-directional shear springs, circumferential joints between adjacent rings; simulating, by a Winkler soil spring, interaction between tunnel and stratum; deriving node equations of intersection of the supports and intersection of the support and segment according to principle of equal displacement and balanced internal force; and combining and solving the above equations to obtain the opening response of the shield tunnel.

### CROSS-REFERENCE TO RELATED APPLICATIONS

The present application claims priority to Chinese Patent Application No. 202311400316.5, filed on Oct. 26, 2023, the content of which is incorporated herein by reference in its entirety.

### TECHNICAL FIELD

The present disclosure relates to the field of shield tunnels, and in particular, to a method for calculating an opening response of a shield tunnel with supports.

### BACKGROUND

With the advancement of urbanization, efforts to alleviate issues such as urban surface space shortage and above-ground traffic congestion have spurred vigorous development of urban underground space. As a crucial part of urban underground space development, the construction of shield tunnel networks faces challenges in interconnecting tunnels, tunnel-to-station links, and tunnel-to-vent connections. The main difficulty lies in the need to breach the tunnel segments for these connections, compromising the structural integrity of shield tunnels and increasing loads on non-opened areas, which is highly detrimental to tunnel structures.

In order to ensure smooth progress in connection construction, various engineering measures are typically employed to mitigate the impact of breaches on tunnel structures, with the erection of support structures being particularly significant. In order to optimize the design of these support structures, it is necessary to study the mechanical response characteristics of segments and supports after opening of shield tunnel with supports structure, so as to evaluate the safety of opening conditions and rationality of support schemes, and optimize the support design according to the calculation results to mitigate engineering risks while ensuring construction cost-effectiveness.

At present, extensive research has been conducted on this issue, predominantly focusing on numerical computations and model experiments. Analytical computation methods specifically addressing this problem have not been reported yet. However, analytical calculation methods are widely sought after in engineering design practices due to their computational simplicity and ease of modification.

The state-space method employs the duality theory and state symplectic space based on Hamilton system, and takes the internal force and displacement of energy dual as unknown variables, thereby avoiding the higher order of differential equations and facilitating nimble problem solving. In recent years, the state-space method has been successfully applied in the field of civil engineering to study the static response of segmented lining of the shield tunnel and the static response of a large-diameter pile foundation under a horizontal load. These applications provide references for the application of the state-space method in the calculation of opening response and support response of the shield tunnel considering staggered joints assembly and reinforced supports.

### SUMMARY

The technical problem to be solved by the present disclosure is to provide a method for calculating an opening response of a shield tunnel with supports. This method is to facilitate calculation of the mechanical response of the lining and support after the opening of the shield tunnel with staggered joints assembly and reinforced by supports, which avoids the problems of complex finite element modeling and difficult modification, and provides a basis for the optimization of the support under the opening condition.

Therefore, the method for calculating an opening response of a shield tunnel with supports provided by the present disclosure includes a shield tunnel and a support structure. The shield tunnel consists of a plurality of segments, circumferential joints between adjacent rings and longitudinal joints which are spliced and assembled; the shield tunnel is provided with a rectangular opening; and the support structure consists of a plurality of supports which are rigidly connected; the method for calculate a response of the tunnel segment and the supports after opening includes the following concrete steps: dividing the tunnel segment into a plurality of segments along the longitudinal joint according to the position of the longitudinal joint connected in the circumferential direction, the opening position and the position of the connection between the supports and the segments, using a state equation for transfer inside the segments, using a joint equation for transfer between the segments, and adopting a balance equation at the connection position between the supports and the segments; dividing the supports along the intersection node, and using the state equation to transfer in a single support, and using the balance equation at the intersection node of the supports; considering the shear deformation of the section, and using a Timoshenko beam theory to simulate the mechanical behavior of the lining segments and supports; simulating the mechanical behavior of the longitudinal joints by radial, tangential and rotating three-directional springs, and simulating the mechanical behavior of an inter-ring seam by two-directional shear springs; simulating the interaction between the tunnel and the stratum by a Winkler soil spring. The method for calculating an opening response and a support response of the shield tunnel considering staggered joint assembly and reinforced support is as follows:

The method for calculating an opening response of a shield tunnel with supports includes the shield tunnel and a support structure; the shield tunnel is including a plurality of lining segments, circumferential joints between adjacent rings and longitudinal joints which are spliced and assembled, and the shield tunnel is provided with a rectangular opening, and the support structure consists of a plurality of supports which are rigidly connected; the method for calculating an opening response and a support response of the shield tunnel includes the following steps:

(1) Treating each of the segments as a curved beam with a rectangular section;

A curve radius in the curved beam of the segments is recorded as R, and coordinate axes z-s are established along a radial direction and a tangential direction, with a z direction being the radial direction, a s direction being the tangential direction; a radial displacement is recorded as w, a tangential displacement is recorded as u; at the same time, a rotation angle of the segment cross-section is recorded as φ, a shear force, an axial force and a bending moment on the segment cross-section is recorded as Q, N and M, respectively; and taking each of the segments as an analysis object, and establishing a segment mechanical model of the shield tunnel.

(2) Considering a shear deformation of the segment cross-section under the segment mechanical model of the shield tunnel, simulating, by a Timoshenko beam theory, a mechanical behavior of a lining, and normalizing a mechanical behavior of an inter-ring seam between rings by a radial shear spring coefficient k_{fz} and a tangential shear spring coefficient k_{fs} to obtain a normalized radial shear spring coefficient k̅_{fz} and a normalized tangential shear spring coefficient k̅_{fs}.

Setting a radial soil spring coefficient k_{z} and a tangential soil spring coefficient kₛ, simulating, by a Winkler soil spring, the interaction between the shield tunnel and a stratum, and performing normalization to obtain a normalized radial soil spring coefficient k̅_{z} and a normalized tangential soil spring coefficient k̅ₛ.

Obtaining a radial load q_{z} and a tangential load qₛ borne by the segments, and performing normalization to obtain a normalized radial load q̅_{zi} and a normalized tangential load q̅ₛᵢ.

Establishing a segment state equation.

Solving a standard solution according to the segment state equation, and obtaining a transfer equation and a transfer matrix inside the segments.

(3) Setting a joint radial spring coefficient k_{w}, a joint tangential spring coefficient kᵤ and a joint rotational spring coefficient k_{φ}, and simulating a mechanical behavior of the longitudinal joints of the shield tunnel connected to each other along a circumferential direction of segments using a radial, tangential and rotational three-directional joint spring.

Considering staggered joint assembly of the segments of the shield tunnel, following a principle of a continuous internal force and a discontinuous displacement where at least one of the longitudinal joints connected to each other along the circumferential direction of the segments exists; setting virtual joints where no joint exists, following a principle of both continuous internal force and displacement, establishing a longitudinal joint equation of the shield tunnel connected along the circumferential direction of the segments, transforming the longitudinal joint equation to obtain a transfer equation between a tail end of one segment and a starting end of a next segment, and arranging the transfer equation into a form of a matrix equation to obtain a joint transfer matrix.

(4) Dividing the longitudinal joints connected to each other along the circumferential direction of the segments and connection positions between the supports and the segments of the shield tunnel into multiple segment sections, alternately using the transfer equation inside the segments obtained in step (2) and the transfer equation between the tail end of one segment and the starting end of the next segment obtained in step (3) along the circumferential direction of the shield tunnel according to a sequence of the segment sections, until the circumferential direction turns back to a circle, that is, establishing an initial integral ring matrix equation. A left side of the initial integral ring matrix equation is an initial coefficient matrix right multiplied by a state vector including radial displacements, tangential displacements, section rotation angles, shear forces, axial forces and bending moments of the sections at the tail end and the starting end of all segments after normalization, and a the right side of the initial integral ring matrix equation is a vector including a load integral vector and a zero vector; the initial integral ring matrix equation includes a transfer inside the segments and a joint transfer caused by the longitudinal joints, excluding a transfer at the connection position between the supports and the segments.

(5) A length of the rectangular opening along an axial direction of the shield tunnel being an integer multiple of a width of the segments, and using a free boundary condition for simulation at the rectangular opening, with the internal force being 0, that is, a supplementary condition, constructing a corresponding supplementary coefficient matrix, screening out the internal force corresponding to an opening position in the state vector through a supplementary coefficient matrix, the internal force at the opening position being a corresponding zero vector, thereby obtaining a supplementary opening equation.

(6) Taking each of the supports as a straight beam, considering the shear deformation of the cross section of each of the supports under a support mechanical model, and stimulating the mechanical behavior of the supports by the Timoshenko beam theory.

Establishing a coordinate axis z-s along the straight beam, with the s direction being the axial direction and the z direction being perpendicular to the axial direction; denoting a displacement perpendicular to the axial direction as w and an axial displacement as u; at the same time, considering that the section rotation angle of the straight beam is denoted as φ, and the shear force, axial force and bending moment on the support section are denoted as Q, N and M, respectively, taking each of the supports as an analysis object, establishing a support mechanical model, obtaining a state equation of each of the supports, and solving the equation to obtain a transfer equation inside the supports, and integrating the transfer equations in multiple supports to obtain a total transfer equation inside the supports.

(7) During calculation of the supports, segmenting from an intersection node, calculating, and obtaining a balance equation of a support node at the intersection node during calculation, as rigid connection, according to a principle of same displacement and internal force balance.

(8) Calculating the connection positions between the supports and the segments as rigid connection, and obtaining a balance equation at the intersection of the supports and the segments according to the principle of same displacement and internal force balance.

(9) Integrating the initial integral ring matrix equation obtained in step (4) with the supplementary opening equation obtained in step (5), the transfer equation inside the supports obtained in step (6), the balance equation at the support node obtained in step (7) and the balance equation at the intersection of the supports and segments obtained in step (8) to form a final integral ring matrix equation, and solving a final matrix equation to obtain the state vector including radial displacements, tangential displacements, section rotation angles, shear forces, axial forces and bending moments of the sections at the tail end and the starting end of all segments and the supports after normalization.

Then, obtaining a state vector including radial displacements, tangential displacements, section rotation angles, shear forces, axial forces and bending moments of any section of all segments and the supports after normalization according to the transfer equation inside the segments obtained in step (2) and the transfer equation inside the support obtained in step (6), and performing reverse normalization on the obtained state vector including radial displacements, tangential displacements, section rotation angles, shear forces, axial forces and bending moments of each section after normalization to obtain an opening response of the shield tunnel obtaining optimized structures, positions and quantities of all the segments and the supports, manufacturing all the segments and the supports based on the opening response of the shield tunnel, and constructing the shield tunnel with the segments and the supports based on the optimized structures, positions and quantities.

Shield tunnel designers can optimize the structural form, position and quantity of the reinforcements and supports of the shield tunnel segments according to the obtained opening response and support response of the shield tunnel considering staggered joint assembly and reinforced support, so as to ensure the safe implementation of opening conditions and avoid engineering accidents of staggered joint assembly of the shield tunnel caused by excessive deformation or even segment damage. At the same time, the parameters can be adjusted to calculate the opening response of the shield tunnel corresponding to different opening positions, different joint arrangement forms, different support design solutions and different joint radial spring coefficients k_{w}, joint tangential spring coefficient kᵤ, joint rotation spring coefficient k_{φ}, radial shear spring coefficient k_{fz} and tangential shear spring coefficient k_{fs}, so as to optimize the design solution of shield tunnel opening and support arrangement, reduce risks and save costs as much as possible while ensuring safety.

In step (2), the segment state equation is:

$$\frac{d \overline{x}}{d θ} = \overline{A} \overline{x} + \overline{q} \qquad ( 22 )$$

where x̅ is a state vector including radial displacements, tangential displacements, section rotation angles, shear forces, axial forces and bending moments after normalization, θ is a normalized tangential coordinate, Ā is a normalized system matrix, including section information, material information, shear spring information between rings and soil spring information of the segments, and q̅ is a normalized load vector.

The standard solution of the segment state equation is the transfer equation inside the segments:

$$\overline{x} ( θ ) = \overline{T} ( θ - {θ}_{0} ) \overline{x} ( {θ}_{0} ) + \overline{f} ( θ - {θ}_{0} ) \qquad ( 29 )$$

where x̅ is a state vector including radial displacements, tangential displacements, section rotation angles, shear forces, axial forces and bending moments after normalization on the section with a normalized tangential coordinate of θ, and x̅(θ₀) is a state vector including radial displacements, tangential displacements, section rotation angles, shear forces, axial forces and bending moments after normalization on the section with a normalized tangential coordinate of θ₀.

The matrix T̅(θ−θ₀) is a normalized transfer matrix inside the segments from θ₀ to θ, and the matrix f̅(θ−θ₀) is a normalized load integral vector from θ₀ to θ:

$$\overline{T} ( θ - {θ}_{0} ) = {e}^{\overline{A} ( θ - {θ}_{0} )} , \overline{f} ( θ - {θ}_{0} ) = {\int }_{{θ}_{0}}^{θ} {e}^{\overline{A} ( θ - ξ )} \overline{q} ( ξ ) d ξ \qquad ( 30 )$$

where e is the natural constant, ξ is an integral variable and Ā is a normalized system matrix.

In step (3), the transfer equation between the tail end of one segment and the starting end of the next segment is:

$${\overline{x}}_{0}^{j + 1} = {\overline{G}}^{j} {\overline{x}}_{1}^{j} \qquad ( 35 )$$

where x̅₀^{j+1} is a normalized state vector at the starting end of a (j+1)^{th} segment, x̅₁^{j} is a normalized state vector at the tail end of a j^{th} segment, and GP is a normalized joint transfer matrix of j^{th} joint.

In step (4), the initial integral ring matrix equation is:

$${\overline{mH}}_{1} * \overline{X} = \overline{{mf}_{1}} \qquad ( 38 )$$

where m̅H̅₁ is an initial coefficient matrix, which is obtained by alternately integrating the transfer equation inside the segments obtained in step (2) and the transfer equation between the tail end of one segment and the starting end of the next segment obtained in step (3), X̅ is a state vector including radial displacements, tangential displacements, section rotation angles, shear forces, axial forces and bending moments of the sections at the tail end and the starting end of all segments and the supports after normalization, and m̅f̅₁ is a vector including a load integral vector and a zero vector.

In step (5), the supplementary opening equation is:

$${\overline{mH}}_{2} * \overline{X} = 0 \qquad ( 44 )$$

where m̅H̅₂ is a supplementary coefficient matrix, X̅ is a state vector including radial displacements, tangential displacements, section rotation angles, shear forces, axial forces and bending moments of the sections at the tail end and the starting end of all segments and the supports after normalization; a number of columns of the supplementary coefficient matrix m̅H̅₂ is the same as that of the initial coefficient matrix m̅H̅₁, which is equal to a number of rows of the state vector; a number of rows of the supplementary coefficient matrix m̅H̅₂ is determined by a ratio of a length of the opening along the axial direction of the shield tunnel to a width of the segments, and a number of rows of the zero vector on the right side of the supplementary opening equation is equal to that of the supplementary coefficient matrix m̅H̅₂.

In step (6), the support state equation is:

$$\frac{d \overline{x}}{d θ} = {\overline{A}}_{s} \overline{x} \qquad ( 50 )$$

where x̅ is a state vector including radial displacements, tangential displacements, section rotation angles, shear forces, axial forces and bending moments after normalization, θ is a normalized tangential coordinate, Āₛ, is a normalized system matrix, including section information, material information of each of the supports.

The standard solution to the state equation is the transfer equation:

$$\overline{x} ( θ ) = {\overline{T}}_{s} ( θ - {θ}_{0} ) \overline{x} ( {θ}_{0} ) \qquad ( 57 )$$

where x̅ is a state vector including radial displacements, tangential displacements, section rotation angles, shear forces, axial forces and bending moments after normalization on the section with a normalized tangential coordinate of θ, and x̅(θ₀) in the transfer equation is a state vector including radial displacements, tangential displacements, section rotation angles, shear forces, axial forces and bending moments after normalization on the section with a normalized tangential coordinate of θ₀.

The matrix T̅ₛ(θ−θ₀) is the normalized transfer matrix from θ₀ to θ:

$${\overline{T}}_{s} ( θ - {θ}_{0} ) = {e}^{{\overline{A}}_{s} ( θ - {θ}_{0} )} \qquad ( 58 )$$

where e is the natural constant.

The transfer equation inside the support is:

$${\overline{mH}}_{3} * \overline{X} = 0 \qquad ( 59 )$$

where m̅H̅₃ is a support coefficient matrix, and X̅ is a state vector including radial displacements, tangential displacements, section rotation angles, shear forces, axial forces and bending moments of the sections at the tail end and the starting end of all segments and the supports after normalization.

In step (7), the balance equation at the support node is:

$${\overline{mH}}_{4} * \overline{X} = 0 \qquad ( 74 )$$

where m̅H̅₄ is a node balance matrix, and X̅ is a state vector including radial displacements, tangential displacements, section rotation angles, shear forces, axial forces and bending moments of the sections at the tail end and the starting end of all segments and the supports after normalization.

In step (8), the balance equation at the intersection of the supports and the segments is:

$${\overline{mH}}_{5} ⋆ \overline{X} = 0 \qquad ( 89 )$$

where m̅H̅₅ is a connection balance matrix, and X̅ is a state vector including radial displacements, tangential displacements, section rotation angles, shear forces, axial forces and bending moments of the sections at the tail end and the starting end of all segments and the supports after normalization.

In step (9), the final matrix equation is:

$$\overline{mH} ⋆ \overline{X} = \overline{mf} \qquad ( 92 )$$

$$where$$

$$\overline{mH} = [ \begin{matrix}{\overline{mH}}_{1} \\ {\overline{mH}}_{2} \\ {\overline{mH}}_{3} \\ {\overline{mH}}_{4} \\ {\overline{mH}}_{5}\end{matrix} ] \qquad ( 93. a )$$

$$\overline{mf} = [ \begin{matrix}{\overline{mf}}_{1} \\ 0 \\ 0 \\ 0 \\ 0\end{matrix} ] . \qquad ( 93. b )$$

The final matrix equation is solved to obtain the normalized state vector including radial displacements, tangential displacements, section rotation angles, shear forces, axial forces and bending moments at the starting end and the tail end of all segments and the supports, and then a state vector including radial displacements, tangential displacements, section rotation angles, shear forces, axial forces and bending moments of any section of all segments and the supports after normalization is obtained according to the transfer equations inside the segments and the supports obtained in steps (2) and (6); and reverse normalization is performed on the obtained state vector including radial displacements, tangential displacements, section rotation angles, shear forces, axial forces and bending moments of each section after normalization to obtain an opening response of the shield tunnel considering staggered joint assembly and reinforcement supports.

The soil spring stiffness coefficient (k_{z}, kₛ) in each ring, the load form (q_{z}, qₛ) of the tunnel, the stiffness (kᵥ, kᵤ, k_{ϕ}) of each longitudinal joint and the stiffness (k_{fz}, k_{fs}) of the inter-ring joint are not assumed in the above derivation process. According to the actual needs, the soil spring stiffness of each segment ring, the stiffness of the inter-ring joint of each joint and the load of the tunnel are assigned with values, to take into account the inhomogeneity of strata along the longitudinal direction of the tunnel, the difference of joint stiffness values and the influence of arbitrary load forms. At the same time, the above derivation does not limit the layout, material and cross section of the supports, and values can be assigned according to the actual working conditions to study the influence of different support layout on the opening response of the shield tunnel and optimize the support solution.

Compared with the prior art, the present disclosure has the following advantages:

The present disclosure provides a novel method for calculating an opening response of a shield tunnel with supports. The correctness of the proposed method is validated by comparing with the results from the finite element model established in ABAQUS and existing analytical solutions. The method herein facilitates the calculation of mechanical responses of each ring and supports after staggered joint assembly and support reinforcement of shield tunnel opening. In contrast to traditional complex finite element modeling approaches, this method significantly simplifies computational processes and model adjustments, enabling engineers to streamline the design and optimization of opening segments and adjacent segments, as well as support schemes. These technical features not only enhance design efficiency but also provide practical theoretical foundations and feasibility analyses for engineering implementation stages.

### BRIEF DESCRIPTION OF DRAWINGS

FIG. 1 is a schematic diagram of the state equation construction route;

FIG. 2 is a schematic diagram of load;

FIG. 3 is a schematic diagram of a three-ring curved beam calculation model;

FIGS. 4(a)-4(b) are a schematic diagram of a longitudinal joint inside the ring, in which FIG. 4(a) is a schematic diagram of a three-directional spring joint and FIG. 4(b) is a schematic diagram of a virtual joint;

FIGS. 5(a)-5(b) are a schematic diagram of the calculation model of shield tunnel with supports, in which FIG. 5(a) is a schematic side view, and FIG. 5(b) is a support arrangement and opening indication view;

FIG. 6 is a schematic diagram of a straight beam calculation model;

FIGS. 7(a)-7(e) are a schematic view of a joint inside the supports, in which FIG. 7(a) is a Type-A joint, FIG. 7(b) is a Type-B joint, FIG. 7(c) is a Type-C joint, FIG. 7(d) is a Type-D joint, and FIG. 7(e) is a Type-E joint;

FIGS. 8(a)-8(e) are a schematic view of a connecting joint of the supports and the segments, in which FIG. 8(a) is Type-F joint, FIG. 8(b) is Type-G joint, FIG. 8(c) is Type-H joint, FIG. 8(d) is Type-I joint, FIG. 8(e) is Type-J joint, and FIG. 8(f) is Type-K joint;

FIG. 9 is a schematic diagram of a finite element model; and

FIGS. 10(a)-10(f) show the mechanical response results of the 8^{th} ring of lining considering staggered joint assembly and supports in a working condition of shield tunnel opening.

### DESCRIPTION OF EMBODIMENTS

In the following, the technical solution in the embodiment of the present disclosure will be clearly and completely described in combination with the embodiment of the present disclosure. Obviously, the described embodiment is only a part of the embodiment of the present disclosure, but not the whole embodiment. Based on the embodiments in the present disclosure, all other embodiments obtained by ordinary technicians in the field without creative labor belong to the scope of protection of the present disclosure.

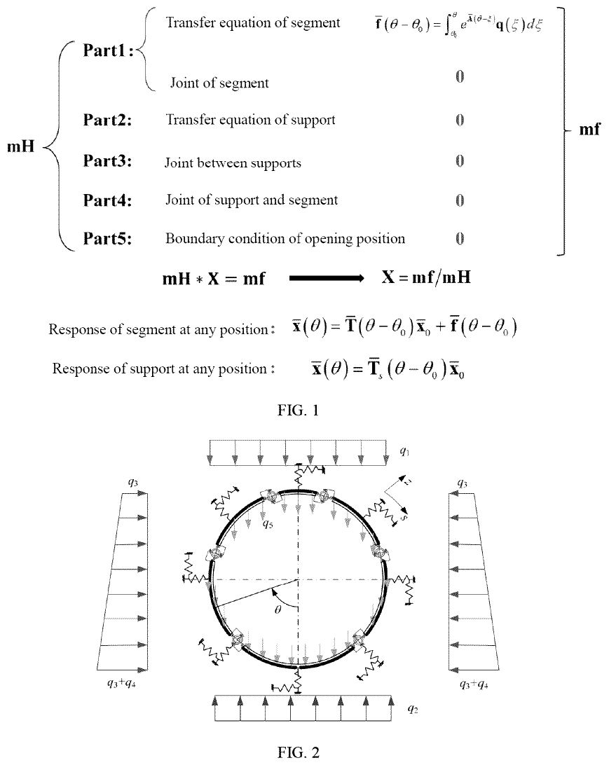

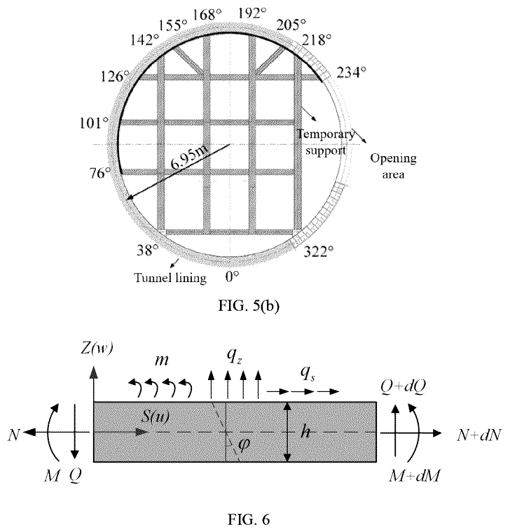

Referring to the technical route of FIG. 1, the present disclosure provides a method for calculating an opening response of a shield tunnel with supports, which includes a shield tunnel and a supporting structure. As shown in FIGS. 5(a)-5(b), the shield tunnel is including a plurality of lining segments, circumferential joints between adjacent rings and longitudinal joints which are spliced and assembled, and the shield tunnel is provided with a rectangular opening, and the support structure consists of a plurality of supports which are rigidly connected; the method for calculating an opening response and a support response of the shield tunnel includes the following steps:

(1) Treating one segment as a curved beam with a rectangular section.

A curve radius in the curved beam of the segments is recorded as R, and coordinate axes z-s are established along a radial direction and a tangential direction, with a z direction being the radial direction, a s direction being the tangential direction; a radial displacement is recorded as w, a tangential displacement is recorded as u; at the same time, considering a rotation angle of the segment cross-section being recorded as p, and a shear force, an axial force and a bending moment on the segment cross-section being recorded as Q, N and M, respectively, a segment curved beam is taken as an analysis object, and a segment mechanical model of the shield tunnel is established.

(2) Considering a shear deformation of the segment cross-section under the segment mechanical model of the shield tunnel, simulating, by a Timoshenko beam theory, a mechanical behavior of a lining, and normalizing a mechanical behavior of an inter-ring seam between rings by a radial shear spring coefficient k_{fz} and a tangential shear spring coefficient k_{fs} to obtain a normalized radial shear spring coefficient k̅_{fz} and a normalized tangential shear spring coefficient k̅_{fs}.

Setting a radial soil spring coefficient k_{z} and a tangential soil spring coefficient kₛ, simulating, by a Winkler soil spring, the interaction between the shield tunnel and a stratum, and performing normalization to obtain a normalized radial soil spring coefficient k̅_{z} and a normalized tangential soil spring coefficient k̅ₛ.

Obtaining a radial load q_{z} and a tangential load qₛ borne by the segments, and performing normalization to obtain a normalized radial load q̅_{zi} and a normalized tangential load q̅ₛᵢ after normalization.

Establishing a segment state equation.

Solving a standard solution according to the segment state equation to obtain a transfer equation and a transfer matrix inside the segments.

(3) Setting a joint radial spring coefficient k_{w}, a joint tangential spring coefficient kᵤ and a joint rotational spring coefficient k_{φ}, and simulating a mechanical behavior of the longitudinal joint of the shield tunnel connected along a circumferential direction of the segments by using a radial, tangential and rotational three-directional joint spring.

Considering staggered joint assembly of the segments of the shield tunnel, following a principle of a continuous internal force and a discontinuous displacement where there are longitudinal joints connected circumferentially to the segments; setting virtual joints where there is no joint, following a principle of both continuous internal force and displacement, establishing a longitudinal joint equation of the shield tunnel connected along the circumferential direction of the segments, transforming the longitudinal joint equation to obtain a transfer equation between a tail end of one segment and a starting end of a next segment, and arranging the transfer equation into a form of a matrix equation to obtain a joint transfer matrix.

(4) Dividing the longitudinal joints and connection positions between the supports and the segments along the circumferential direction of the shield tunnel into a plurality of segments, alternately using the transfer equation inside the segments obtained in step (2) and the transfer equation between the tail end of one segment and the starting end of the next segment obtained in step (3) along the circumferential direction of the shield tunnel according to a sequence of the plurality of segments, until the circumferential direction turns back to a circle, that is, establishing an initial integral ring matrix equation. On the left side of the initial integral ring matrix equation is an initial coefficient matrix multiplied by a state vector including radial displacements, tangential displacements, section rotation angles, shear forces, axial forces and bending moments of the sections at the tail end and the starting end of all segments after normalization, and on the right side of the initial integral ring matrix equation is a vector including a load integral vector and a zero vector; the initial integral ring matrix equation includes a transfer inside the segment and a joint transfer caused by the joint, excluding a transfer at the connection position between the supports and the segments.

(5) A length of the rectangular opening along the axial direction of the shield tunnel being an integer multiple of a width of the segments, and using a free boundary condition for simulation at the rectangular opening, with the internal force being 0, which is a supplementary condition, constructing a corresponding supplementary coefficient matrix, screening out the internal force corresponding to an opening position in the state vector through the supplementary coefficient matrix, so that the internal force at the opening position is a corresponding zero vector, thereby obtaining a supplementary opening equation.

(6) Taking one support as a straight beam, considering the shear deformation of the cross section of the supports under a support mechanical model, and stimulating the mechanical behavior of the supports by the Timoshenko beam theory.

Establishing a coordinate axis z-s along the straight beam of the supports, with the s direction being the axial direction and the z direction being perpendicular to the axial direction; denoting a displacement perpendicular to the axial direction as w and an axial displacement as u; at the same time, considering that the section rotation angle of the straight beam is denoted as φ, and the shear force, axial force and bending moment on the support section are denoted as Q, N and M, respectively; taking one support as an analysis object, establishing a support mechanical model, obtaining a state equation of the supports, and solving the equation to obtain a transfer equation inside the supports, and integrating the transfer equations in multiple supports to obtain a total transfer equation inside the supports.

(7) During calculation of the supports, segmenting from an intersection node, calculating according to rigid connection, and obtaining a balance equation of a support node at the intersection node according to a principle of same displacement and internal force balance.

(8) Calculating the connection positions between the supports and the segments according to rigid connection, and obtaining a balance equation at the intersection of the supports and the segments according to the principle of same displacement and internal force balance.

(9) Integrating the initial integral ring matrix equation obtained in step (4) with the supplementary opening equation obtained in step (5), the transfer equation inside the supports obtained in step (6), the balance equation at the support node obtained in step (7) and the balance equation at the intersection of the supports and segments obtained in step (8) to form a final integral ring matrix equation, and solving the final matrix equation to obtain the state vector including radial displacements, tangential displacements, section rotation angles, shear forces, axial forces and bending moments of the sections at the tail end and the starting end of all segments and the supports after normalization.

Then, obtaining a state vector including radial displacements, tangential displacements, section rotation angles, shear forces, axial forces and bending moments of any section of all segments and the supports after normalization according to the transfer equation inside the segments obtained in step (2) and the transfer equation inside the supports obtained in step (6), and performing reverse normalization on the obtained state vector including radial displacements, tangential displacements, section rotation angles, shear forces, axial forces and bending moments of each section after normalization to obtain an opening response of the shield tunnel considering staggered joint assembly and reinforcement supports.

As shown in FIG. 3, firstly considering the curved beam system including adjacent three rings, the subscript i is used to distinguish the physical quantities of the three rings, with the values of i being 1, 2 and 3. In the above step (2), the displacements u_{zi}(s, z) and uₛᵢ(s, z) along the coordinates z and s at any point on the cross section is:

$${u}_{zi} ( s , z ) = {w}_{i} ( s ) , {u}_{si} ( s , z ) = {u}_{i} ( s ) - z {φ}_{i} ( s ) \qquad ( 1 )$$

where wᵢ(s), uᵢ(s), φᵢ(s) are the radial displacement, tangential displacement and rotation angle of the section with a circumferential coordinate s of the i^{th} ring of lining, respectively. s and z are the coordinates on the s axis and the z axis, respectively. The normal strain εᵢ and shear strain γᵢ at any point on the section with the circumferential coordinate s of the i^{th} ring of lining are as follows, respectively:

$${ε}_{i} = \frac{1}{1 + z / R} ( {ε}_{0 i} + z {κ}_{0 i} ) , {γ}_{i} = \frac{1}{1 + z / R} {γ}_{0 i} \qquad ( 2 )$$

where z is the coordinate on the z axis, R is the curve radius in the lining, and the rest are defined in equation (3):

$${ε}_{0 i} = \frac{{du}_{i}}{d s} + \frac{{w}_{i}}{R} , {κ}_{0 i} = - \frac{d {φ}_{i}}{d s} , {γ}_{0 i} = \frac{d {w}_{i}}{d s} - \frac{{u}_{i}}{R} - {φ}_{i} \qquad ( 3 )$$

where wᵢ, uᵢ, φᵢ are the radial displacement, tangential displacement and rotation angle of the section with the circumferential coordinate s of the i^{th} ring of lining, respectively. R is the curve radius in the lining. ε₀ᵢ, γ₀ᵢ, κ₀ᵢ are the normal strain, shear strain and section rotation angle change of the middle curve position at the circumferential coordinate s of the i^{th} ring of lining, respectively.

According to Hooke's law, the normal stress a and shear stress T at any point on the section with the circumferential coordinate s of the i^{th} ring of lining are as follows, respectively:

$${σ}_{i} = E {ε}_{i} = \frac{E}{1 + z / R} ( {E}_{0 i} + z {κ}_{0 i} ) , {τ}_{i} = κ G {γ}_{i} = \frac{κ G}{1 + z / R} {γ}_{0 i} \qquad ( 4 )$$

where E and G are Young's modulus and shear modulus of the lining, κ is the shear correction coefficient of the lining section, z is the coordinate on the z axis, and R is the radius of the middle curve of the lining. Therefore, the internal force on the section is:

$${N}_{i} = \int {\int }_{A} {σ}_{i} d A = EA β ( \frac{d {u}_{i}}{d s} + \frac{{w}_{i}}{R} ) - EAR ( 1 - β ) \frac{d {φ}_{i}}{d s} ( i = 1 , 2 , 3 ) \qquad ( 5 )$$

$${M}_{i} = \int {\int }_{A} {σ}_{i} zd A = EAR ( 1 - β ) ( \frac{d {u}_{i}}{d s} + \frac{{w}_{i}}{R} ) + {EAR}^{2} ( 1 - β ) \frac{d {φ}_{i}}{d s} ( i = 1 , 2 , 3 ) \qquad ( 6 )$$

$${Q}_{i} = \int {\int }_{A} {τ}_{i} d A = κ GA β ( \frac{d {w}_{i}}{d s} - \frac{{u}_{i}}{R} - {φ}_{i} ) ( i = 1 , 2 , 3 ) \qquad ( 7 )$$

In equations (5)-(7), Nᵢ, Mᵢ, Qᵢ are the axial force, bending moment and shear force on the section with the circumferential coordinate s of the i^{th} ring of lining, respectively. wᵢ, uᵢ, φᵢ are the radial displacement, tangential displacement and section rotation angle with the circumferential coordinate s of the i^{th} ring of lining, respectively. R, and A are the curve radius and cross-sectional area in the lining, respectively. E and G are Young's modulus and shear modulus of the lining material, respectively. κ is the shear correction coefficient of the lining section. The parameter β is a dimensionless quantity related to the section shape, which is defined as:

$$β = \frac{1}{A} \int {\int }_{A} \frac{1}{1 + z / R} d A \qquad ( 8 )$$

where R, and A are the curve radius and cross-sectional area in the lining, respectively, and z is the coordinate on the z axis.

The total potential energy of the system can be written as the sum of the potential energy π₁, π₂, π₃ of three segments (the potential energy of each segment includes the elastic potential energy of segment, the potential energy of soil spring and the work done by external force) and the potential energy π₄, π₅ of two circumferential joints between adjacent rings, namely:

$$π = {π}_{1} + {π}_{2} + {π}_{3} + {π}_{4} + {π}_{5} \qquad ( 9 )$$

$$where$$

$${π}_{i} = \frac{1}{2} {\int }_{L} [ {Q}_{i} {γ}_{0 i} + {N}_{i} {ε}_{0 i} + {M}_{i} {κ}_{0 i} ] ds - {\int }_{L} ( {q}_{si} {bu}_{i} - \frac{1}{2} {k}_{s} {bu}_{i}^{2} + {q}_{zi} {bw}_{i} - \frac{1}{2} {k}_{z} {{bw}_{i}}^{2} ) ds ( i = 1 , 2 , 3 ) \qquad ( 10 )$$

$${π}_{4} = \frac{1}{2} {\int }_{L} [ {k}_{fz} {h ( {w}_{1} - {w}_{2} )}^{2} + {k}_{fs} {h ( {u}_{1} - {u}_{2} )}^{2} ] ds \qquad ( 11 )$$

$${π}_{5} = \frac{1}{2} {\int }_{L} [ {k}_{fz} {h ( {w}_{2} - {w}_{3} )}^{2} + {k}_{fs} {h ( {u}_{2} - {u}_{3} )}^{2} ] ds \qquad ( 12 )$$

In equations (10)-(12), Nᵢ, Mᵢ, and Qᵢ are the axial force, bending moment and shear force of the i^{th} ring of lining, respectively. wᵢ, uᵢ, and φᵢ are the radial displacement, tangential displacement and section rotation angle of the i^{th} ring of lining, respectively. q_{zi}, and qₛᵢ represent the radial load and tangential load of the i^{th} ring of lining, respectively. b is the width of segments, and h is the thickness of segments. k_{z}, kₛ represent the stiffness coefficients of radial soil spring and tangential soil spring, respectively. k_{fz}, and k_{fs} represent the radial and tangential stiffness coefficients of the shear spring between rings, respectively.

The potential energy of the system is subjected to variation, and according to the principle of minimum potential energy, the balance equation that internal force needs to satisfy can be obtained as follows:

$$\frac{{N}_{i}}{R} - \frac{d {Q}_{i}}{d s} + ( {k}_{z} b + {k}_{fz} h ) {w}_{i} - {k}_{fz} {hw}_{2} - {q}_{zi} b = 0 ( i = 1 , 3 ) \qquad ( 13. a )$$

$$\frac{{N}_{2}}{R} - \frac{d {Q}_{2}}{d s} + ( {k}_{z} b + 2 {k}_{fz} h ) {w}_{2} - {k}_{fz} {hw}_{1} - {k}_{fz} {hw}_{3} - {q}_{z 2} b = 0 \qquad ( 13. b )$$

$$- \frac{{Q}_{i}}{R} - \frac{d {N}_{i}}{d s} + ( {k}_{s} b + {k}_{fs} h ) {u}_{i} - {k}_{fs} {hu}_{2} - {q}_{si} b = 0 ( i = 1 , 3 ) \qquad ( 13. c )$$

$$- \frac{{Q}_{2}}{R} - \frac{d {N}_{2}}{d s} + ( {k}_{s} b + 2 {k}_{fs} h ) {u}_{2} - {k}_{fs} {hu}_{1} - {k}_{fs} {hu}_{3} - {q}_{s 2} b = 0 \qquad ( 13 . d )$$

$$- {Q}_{i} + \frac{d {M}_{i}}{d s} = 0 ( i = 1 , 2 , 3 ) \qquad ( 13. e )$$

In equation (13), Nᵢ, Mᵢ, and Qᵢ are the axial force, bending moment and shear force of the i^{th} ring of lining, respectively. N₂, M₂, and Q₂ are the axial force, bending moment and shear force of the second ring of lining, respectively. wᵢ, and uᵢ are the radial displacement and tangential displacement of the i^{th} ring of lining, respectively. w₁, and u₁ are the radial displacement and tangential displacement of the first ring of lining, respectively. w₂, and u₂ are the radial displacement and tangential displacement of the second ring of lining, respectively. w₃, u₃ are the radial displacement and tangential displacement of the third ring of lining, respectively. q_{zi}, and qₛᵢ represent the radial load and tangential load of the i^{th} ring of lining, respectively. q_{z2}, and qₛ₂ represent the radial load and tangential load of the second ring of lining, respectively. b is the width of segments, and h is the thickness of segments. k_{z}, and kₛ represent the stiffness coefficients of radial soil spring and tangential soil spring, respectively. k_{fz}, and k_{fs} represent the radial and tangential stiffness coefficients of the shear spring between rings, respectively.

Equations (5)-(7) and (13) are rewritten in matrix forms, then

$$\frac{dx}{ds} = Ax + q \qquad ( 14 )$$

$$where$$

$$x = {[ \begin{matrix}{w}_{1} & {u}_{1} & {φ}_{1} & {Q}_{1} & {N}_{1} & - {M}_{1} & {w}_{2} & {u}_{2} & {φ}_{2} & {Q}_{2} & {N}_{2} & - {M}_{2} & {w}_{3} & {u}_{3} & {φ}_{3} & {Q}_{3} & {N}_{3} & - {M}_{3}\end{matrix} ]}^{T} \qquad ( 15 )$$

$$q = {[ \begin{matrix}0 & 0 & 0 & - {q}_{z 1} b & - {q}_{s 1} b & 0 & 0 & 0 & 0 & - {q}_{z 2} b & - {q}_{s 2} b & 0 & 0 & 0 & 0 & - {q}_{z 3} b & - {q}_{s 3} b & 0\end{matrix} ]}^{T} \qquad ( 16 )$$

$$A = [ \begin{matrix}D & C & 0 \\ C & B & C \\ 0 & C & D\end{matrix} ] \qquad ( 17 )$$

$${B}_{12} = - {B}_{21} == {B}_{45} = - {B}_{54} == \frac{1}{R} , {B}_{13} = {B}_{64} = 1 , {B}_{14} = \frac{1}{κ GA β} , {B}_{25} = \frac{1}{E A} , \qquad ( 18 )$$

$${B}_{26} = {B}_{35} = - \frac{1}{EAR} , {B}_{36} = - \frac{β}{{EAR}^{2} ( 1 - β )} , {B}_{41} = {k}_{z} b + 2 {k}_{fz} h , {B}_{51} = {k}_{s} b + 2 {k}_{fs} h$$

$${D}_{12} = - {D}_{21} == {D}_{45} = - {D}_{54} == \frac{1}{R} , {D}_{13} = {D}_{64} = 1 , {D}_{14} = \frac{1}{κ GA β} , {D}_{25} = \frac{1}{EA} , \qquad ( 19 )$$

$${D}_{26} = {D}_{35} = - \frac{1}{EAR} , {D}_{36} = - \frac{β}{{EAR}^{2} ( 1 - β )} , {D}_{41} = {k}_{z} b + {k}_{fz} h , {D}_{51} = {k}_{s} b + {k}_{fs} h$$

$${C}_{41} = - {k}_{fz} h , {C}_{42} = - {k}_{fs} h \qquad ( 20 )$$

In equations (15)-(20), N₁, M₁, and Q₁ are the axial force, bending moment and shear force of the first ring of lining, respectively. N₂, M₂, and Q₂ are the axial force, bending moment and shear force of the second ring of lining, respectively. N₃, M₃, and Q₃ are the axial force, bending moment and shear force of the third ring of lining, respectively. w₁, u₁, and φ₁ are the radial displacement, tangential displacement and section rotation angle of the first ring of lining, respectively. w₂, u₂, and φ₂ are the radial displacement, tangential displacement and section rotation angle of the second ring of lining, respectively. w₃, u₃, and φ₃ are the radial displacement, tangential displacement and section rotation angle of the third ring of lining, respectively. q_{z1}, and qₛ₁ represent the radial load and tangential load of the first ring of lining, respectively. q_{z2}, and qₛ₂ represent the radial load and tangential load of the second ring of lining, respectively. q_{z3}, and qₛ₃ represent the radial load and tangential load of the third ring of lining, respectively. b is the width of segments, and h is the thickness of segments. k_{z}, and kₛ represent the stiffness coefficients of radial soil spring and tangential soil spring, respectively. k_{fz}, and k_{fs} represent the radial and tangential stiffness coefficients of the shear spring between rings, respectively. R, and A are the curve radius and cross-sectional area in the lining, respectively. E and G are Young's modulus and shear modulus of the lining materials, respectively. κ is the shear correction coefficient of the lining section. The parameter β is a dimensionless quantity related to the cross-section shape, as shown in Equation (8).

The physical quantities in the above equation are normalized as follows.

$$s = R θ , w = R \overline{w} , u = R \overline{u} , φ = \overline{φ} , Q = EA \overline{Q} , N = EA \overline{N} , M = EAR \overline{M} , \qquad ( 21 )$$

$${k}_{z} = \frac{EA}{{R}^{2} b} {\overline{k}}_{z} , {k}_{s} = \frac{EA}{{R}^{2} b} \overline{{k}_{s}} , {k}_{fz} = \frac{EA}{{R}^{2} h} {\overline{k}}_{fz} , {k}_{fs} = \frac{EA}{{R}^{2} h} {\overline{k}}_{fs} ,$$

$${q}_{z} = \frac{EA}{Rb} {\overline{q}}_{z} , {q}_{s} = \frac{EA}{Rb} {\overline{q}}_{s} .$$

where R, and A are the curve radius and cross-sectional area in the lining, respectively. E is Young's modulus of the lining material. b is the width of segments, and h is the thickness of segments. N, M, and Q are the axial force, bending moment and shear force of the lining, respectively. w, u and φ are the radial displacement, tangential displacement and section rotation angle of the lining, respectively. k_{z}, and kₛ represent the stiffness coefficients of radial soil spring and tangential soil spring, respectively. k_{fz}, and k_{fs} represent the radial and tangential stiffness coefficients of the shear spring between rings, respectively. s is the coordinate on the s axis. All the physical quantities with crossed marks above are the physical quantities normalized from the original physical quantities, and θ is the physical quantity normalized from s.

The segment state equation can be obtained:

$$\frac{d \overline{x}}{d θ} = \overline{A} \overline{x} + \overline{q} \qquad ( 22 )$$

$$\overline{x} = {[ \begin{matrix}{\overline{w}}_{1} & {\overline{u}}_{1} & {\overline{φ}}_{1} & {\overline{Q}}_{1} & {\overline{N}}_{1} & - {\overline{M}}_{1} & {\overline{w}}_{2} & {\overline{u}}_{2} & {\overline{φ}}_{2} & {\overline{Q}}_{2} & {\overline{N}}_{2} & - {\overline{M}}_{2} & {\overline{w}}_{3} & {\overline{u}}_{3} & {\overline{φ}}_{3} & {\overline{Q}}_{3} & {\overline{N}}_{3} & - {\overline{M}}_{3}\end{matrix} ]}^{T} \qquad ( 23 )$$

$$\overline{q} = {[ \begin{matrix}0 & 0 & 0 & - {\overline{q}}_{z 1} & - {\overline{q}}_{s 1} & 0 & 0 & 0 & 0 & - {\overline{q}}_{z 2} & - {\overline{q}}_{s 2} & 0 & 0 & 0 & 0 & - {\overline{q}}_{z 3} & - {\overline{q}}_{s 3} & 0\end{matrix} ]}^{T} \qquad ( 24 )$$

$$\overline{A} = [ \begin{matrix}\overline{D} & \overline{C} & 0 \\ \overline{C} & \overline{B} & \overline{C} \\ 0 & \overline{C} & \overline{D}\end{matrix} ] \qquad ( 25 )$$

$${\overline{B}}_{12} = {\overline{B}}_{13} = - {\overline{B}}_{21} = {\overline{B}}_{25} = - {\overline{B}}_{26} = - {\overline{B}}_{35} = {\overline{B}}_{45} = - {\overline{B}}_{54} = - {\overline{B}}_{64} = 1 , \qquad ( 26 )$$

$${\overline{B}}_{14} = \frac{E}{κ G β} , {\overline{B}}_{36} = - \frac{β}{( 1 - β )} , {\overline{B}}_{41} = {\overline{k}}_{z} + 2 {\overline{k}}_{fz} , {\overline{B}}_{52} = {\overline{k}}_{s} + 2 {\overline{k}}_{fs}$$

$${\overline{D}}_{12} = {\overline{D}}_{13} = - {\overline{D}}_{21} = {\overline{D}}_{25} = - {\overline{D}}_{26} = - {\overline{D}}_{35} = {\overline{D}}_{45} = - {\overline{D}}_{54} = - {\overline{D}}_{64} = 1 , \qquad ( 27 )$$

$${\overline{D}}_{14} = \frac{E}{κ G β} , {\overline{D}}_{36} = - \frac{β}{( 1 - β )} , {\overline{D}}_{41} = {\overline{k}}_{z} + {\overline{k}}_{fz} , {\overline{D}}_{52} = \overline{{k}_{s}} + {\overline{k}}_{fs}$$

$${\overline{C}}_{41} = - {\overline{k}}_{fz} , {\overline{C}}_{52} = - {\overline{k}}_{fs} \qquad ( 28 )$$

In equations (23)-(28), N̅₁, M̅₁, and Q̅₁ are the normalized axial force, bending moment and shear force of the first ring of lining, respectively. N̅₂, M̅₂, and Q̅₂ are the normalized axial force, bending moment and shear force of the second ring of lining, respectively. N̅₃, M̅₃, and Q̅₃ are the normalized axial force, bending moment and shear force of the third ring of lining, respectively. w̅₁, ū₁, and φ̅₁ are the normalized radial displacement, tangential displacement and section rotation angle of the first ring of lining, respectively. w̅₂, ū₂, and φ̅₂ are the normalized radial displacement, tangential displacement and section rotation angle of the second ring of lining, respectively. w̅₃, ū₃, and φ̅₃ are the normalized radial displacement, tangential displacement and section rotation angle of the third ring of lining, respectively. q̅_{z1}, and q̅ₛ₁ represent the normalized radial load and tangential load of the first ring of lining, respectively. q̅_{z2}, and q̅ₛ₂ represent the normalized radial load and tangential load of the second ring of lining, respectively. q̅_{z3}, and q̅ₛ₃ representing the normalized radial load and tangential load of the third ring of lining, respectively. k̅_{z}, and k̅ₛ represent the normalized stiffness coefficients of the radial soil spring and tangential soil spring, respectively. f̅_{fz}, and k̅_{fs} represent the normalized radial and tangential stiffness coefficients of the shear spring between rings, respectively. R and A are the curve radius and cross-sectional area in the lining, respectively. E and G are Young's modulus and shear modulus of the lining material, respectively. κ is the cross-section shear correction coefficient. The parameter β is a dimensionless quantity related to the cross-section shape, as shown in Equation (8).

The standard solution of equation (22) is

$$\overline{x} ( θ ) = \overline{T} ( θ - {θ}_{0} ) \overline{x} ( {θ}_{0} ) + \overline{f} ( θ - {θ}_{0} ) \qquad ( 29 )$$

Equation (29) is the transfer relation between the two state vectors x̅(θ) and x̅(θ₀) with coordinates of θ and θ₀ on the tunnel. T̅(θ−θ₀) is the transfer matrix of the system and f̅(θ−θ₀) is the load integral vector of the system, and their expressions are as follows:

$$\overline{T} ( θ - {θ}_{0} ) = {e}^{\overline{A} ( θ - {θ}_{0} )} , \overline{f} ( θ - {θ}_{0} ) = {\int }_{{θ}_{0}}^{θ} {e}^{\overline{A} ( θ - ξ )} \overline{q} ( ξ ) d ξ \qquad ( 30 )$$

In equation (30), e is the natural constant, ξ is an integral variable and Ā is a normalized system matrix.

From the coefficient matrix of the above three rings, the coefficient matrix of in a multi-ring situation can be deduced.

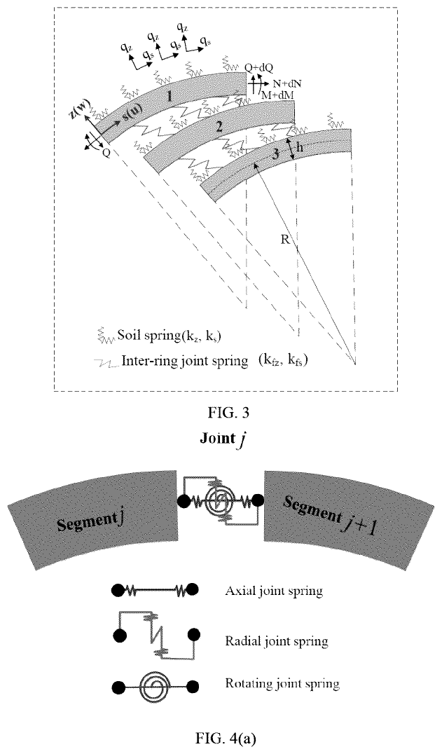

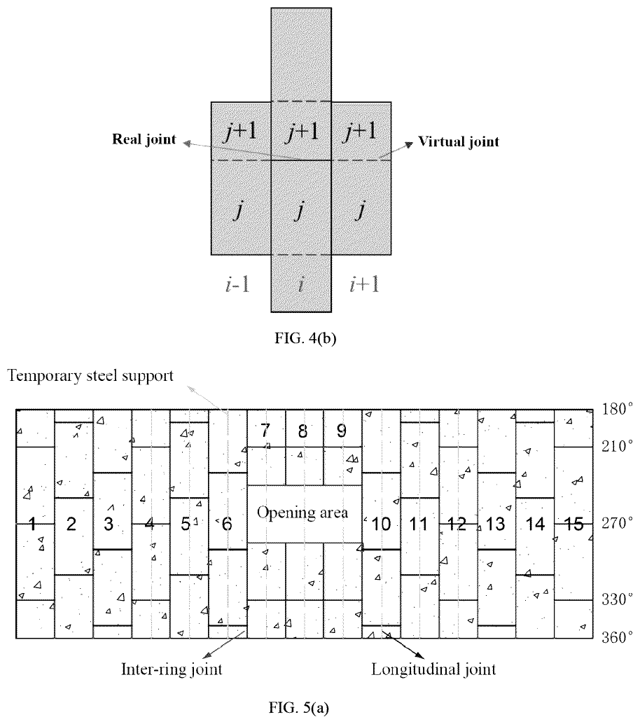

In step (3), as shown in FIG. 4(a), the longitudinal joint can transmit shear force, axial force and bending moment, and the magnitude of internal force is determined by the relative displacement at the joint, which satisfies the continuity conditions of force and discontinuity conditions of displacement at the joint. According to the constitutive relation of the three-directional spring, the physical quantity transfer relationship between the two sides of the inter-ring joint is as follows:

$${Q}_{i 0}^{j + 1} = {Q}_{i 1}^{j} = {k}_{w} ( {w}_{i 0}^{j + 1} - {w}_{i 1}^{j} ) \qquad ( 31. a )$$

$${N}_{i 0}^{j + 1} = {N}_{i 1}^{j} = {k}_{u} ( {u}_{i 0}^{j + 1} - {u}_{i 1}^{j} ) \qquad ( 31. b )$$

$${M}_{i 0}^{j + 1} = {M}_{i 1}^{j} = {k}_{φ} ( {φ}_{i 1}^{j} - {φ}_{i 0}^{j + 1} ) \qquad ( 31. c )$$

In equation (31), the subscript i indicates the serial number of the lining ring, the subscript 0 indicates the starting end of the segments, the subscript 1 indicates the tail end of the segments, and the superscript j and j+1 indicate the serial number of the segment and the serial number of the joint. k_{w}, kᵤ, and k_{φ} represent the radial, circumferential and rotational spring stiffness of the longitudinal joint inside the ring, respectively. wᵢ₁^{j}, uᵢ₁^{j}, qᵢ₁^{j}, Qᵢ₁^{j}, Nᵢ₁^{j}, and Mᵢ₁^{j} represent the radial displacement, tangential displacement, section rotation angle, shear force, axial force and bending moment at the tail end of the j^{th} segment of the i^{th} ring, respectively. wᵢ₀^{j+1}, uᵢ₀^{j+1}, φᵢ₀^{j+1}, Qᵢ₀^{j+1}, Nᵢ₀^{j+1}, and Mᵢ₀^{j+1} represent the radial displacement, tangential displacement, section rotation angle, shear force, axial force and bending moment at the starting end of the (j+1)^{th} segment of the i^{th} ring, respectively.

Considering that shield tunnels are mostly assembled by staggered joints, as shown in FIG. 4(b), virtual joints are introduced to unify joint treatment. The internal force and displacement on both sides of the virtual joint are continuous, namely:

$${w}_{i 0}^{j + 1} = {w}_{i 1}^{j} , {u}_{i 0}^{j + 1} = {u}_{i 1}^{j} , {φ}_{i 1}^{j} = {φ}_{i 0}^{j + 1} , {Q}_{i 0}^{j + 1} = {Q}_{i 1}^{j} , {N}_{i 0}^{j + 1} = {N}_{i 1}^{j} , {M}_{i 0}^{j + 1} = {M}_{i 1}^{j} \qquad ( 32 )$$

In equation (32), the subscript i indicates the serial number of the lining ring, the subscript 0 indicates the starting end of the segments, the subscript 1 indicates the tail end of the segments, and the superscript j and j+1 indicate the serial number of the segments and the serial number of the joint. wᵢ₁^{j}, uᵢ₁^{j}, φᵢ₁^{j}, Qᵢ₁^{j}, Nᵢ₁^{j}, and Mᵢ₁^{j} represent the radial displacement, tangential displacement, section rotation angle, shear force, axial force and bending moment at the tail end of the j^{th} segment of the i^{th} ring, respectively. wᵢ₀^{j+1}, uᵢ₀^{j+1}, φᵢ₀^{j+1}, Qᵢ₀^{j+1}, Nᵢ₀^{j+1}, and Mᵢ₀^{j+1} represent the radial displacement, tangential displacement, section rotation angle, shear force, axial force and bending moment at the starting end of the (j+1)^{th} segment of the i^{th} ring, respectively.

Taking the three-ring ABA staggered joint assembly as an example, the above relationship is written in matrix form:

$${x}_{0}^{j + 1} = {G}^{j} {x}_{1}^{j} = [ \begin{matrix}I & 0 & 0 & 0 & 0 & 0 \\ 0 & I & 0 & 0 & 0 & 0 \\ 0 & 0 & I & H & 0 & 0 \\ 0 & 0 & 0 & I & 0 & 0 \\ 0 & 0 & 0 & 0 & I & 0 \\ 0 & 0 & 0 & 0 & 0 & I\end{matrix} ] {x}_{1}^{j} \qquad ( 33 )$$

where x₀^{j+1} is the state vector of the starting end of the (j+1)^{th} segment lining, x₁^{j} is the state vector of the tail end of the j^{th} segment lining, and G^{j} is the joint transfer matrix of the j^{th} joint. I and H are shown in the following equation:

$$I = [ \begin{matrix}1 & 0 & 0 \\ 0 & 1 & 0 \\ 0 & 0 & 1\end{matrix} ] , H = [ \begin{matrix}\frac{1}{{k}_{w}} & 0 & 0 \\ 0 & \frac{1}{{k}_{u}} & 0 \\ 0 & 0 & \frac{1}{{k}_{φ}}\end{matrix} ] \qquad ( 34 )$$

In equation (34), k_{w}, kᵤ, and k_{φ} represent the radial, circumferential and rotational spring stiffness of the longitudinal joint inside the ring, respectively.

Similarly, the transfer equation is subjected to dimensionless treatment, then:

$${\overline{x}}_{0}^{j + 1} = {\overline{G}}^{j} {\overline{x}}_{1}^{j} \qquad ( 35 )$$

Correspondingly:

$$H = [ \begin{matrix}\frac{1}{{k}_{w}} & 0 & 0 \\ 0 & \frac{1}{{k}_{u}} & 0 \\ 0 & 0 & \frac{1}{{k}_{φ}}\end{matrix} ] \qquad ( 36 )$$

$$where$$

$${\overline{k}}_{w} = \frac{{k}_{w} R}{EA} , {\overline{k}}_{u} = \frac{{k}_{u} R}{EA} , {\overline{k}}_{φ} = \frac{{\overline{k}}_{φ}}{EAR} \qquad ( 37 )$$

In equation (37), k_{w}, kᵤ, and k_{φ} represent the radial, circumferential and rotational spring stiffness of the longitudinal joint inside the ring, respectively. R, and A are the curve radius and cross-sectional area in the lining respectively. E is Young's modulus of the lining material. k̅_{w}, k̅ᵤ, and k̅_{φ} are the stiffnesses of the normalized joint springs, respectively.

Based on the above theory, the transfer can be extended from the case of three rings to multi-rings. The integral ring of lining is divided into n blocks along the longitudinal joints (the angles of the longitudinal joints, openings and connections between supports and segments are considered in the division), and the supports are divided into m segments along the nodes, and then the matrix equations are listed. The physical quantity transfer relationship at both ends of the curved beam and the physical quantity transfer relationship at the inter-ring joint are obtained, equations (29) and (35) are used along the circumferential direction of the tunnel, respectively, then:

$${\overline{mH}}_{1} ⋆ \overline{X} = \overline{mf} \qquad ( 38 )$$

$$where$$

$${\overline{mH}}_{1} = [ \begin{matrix}{\overline{mH}}_{11} & {\overline{mH}}_{12} ]\end{matrix} \qquad ( 39 )$$

$${\overline{mH}}_{11} = [ \begin{matrix}- {\overline{T}}^{1} & I & 0 & ⋯ & ⋯ & ⋯ & ⋯ & ⋯ & ⋯ & 0 \\ 0 & - {\overline{G}}^{1} & I & ⋯ & ⋯ & ⋯ & ⋯ & ⋯ & ⋯ & 0 \\ ⋮ & ⋯ & ⋯ & ⋱ & ⋱ & ⋯ & ⋯ & ⋯ & ⋯ & ⋮ \\ ⋮ & ⋯ & ⋯ & - {\overline{G}}^{⋆ p - 1} & {I}^{⋆} & ⋱ & ⋱ & ⋱ & ⋯ & ⋮ \\ ⋮ & ⋯ & ⋱ & ⋱ & - {\overline{T}}^{⋆ p} & {I}^{⋆} & ⋱ & ⋱ & ⋯ & ⋮ \\ ⋮ & ⋯ & ⋯ & ⋱ & ⋱ & {I}^{⋆} & - {\overline{G}}^{⋆ p} & ⋱ & ⋯ & ⋮ \\ ⋮ & ⋯ & ⋯ & ⋯ & ⋱ & ⋱ & - {\overline{T}}^{p + 1} & ⋱ & ⋯ & ⋮ \\ ⋮ & ⋯ & ⋯ & ⋯ & ⋱ & ⋱ & ⋱ & ⋱ & ⋯ & ⋮ \\ ⋮ & ⋯ & ⋯ & ⋯ & ⋯ & ⋱ & ⋱ & ⋱ & - {\overline{T}}^{n} & I \\ I & ⋯ & ⋯ & ⋯ & ⋯ & ⋯ & ⋯ & ⋯ & ⋯ & - {\overline{G}}^{n}\end{matrix} ] \qquad ( 40 )$$

$${\overline{mH}}_{12} = 0 \qquad ( 41 )$$

$$\overline{x} = {[ \begin{matrix}{\overline{x}}_{0}^{1} & {\overline{x}}_{1}^{1} & ⋯ & {\overline{x}}_{1}^{p - 1} & {\overline{x}}_{0}^{⋆ p} & {\overline{x}}_{1}^{⋆ p} & {\overline{x}}_{0}^{p + 1} & ⋯ & {\overline{x}}_{0}^{n} & {\overline{x}}_{1}^{n} & {\overline{x}}_{0}^{\#n + 1} & {\overline{x}}_{1}^{\#n + 1} & ⋯ & ⋯ & {\overline{x}}_{0}^{\#n + m} & {\overline{x}}_{1}^{\#m + n}\end{matrix} ]}^{T} \qquad ( 42 )$$

$$\overline{mf} = {[ \begin{matrix}{\overline{f}}^{1} & 0 & ⋯ & 0 & {\overline{f}}^{⋆ p} & {0}^{⋆} & 0 & ⋯ & {\overline{f}}^{n} & 0\end{matrix} ]}^{T} \qquad ( 43 )$$

In equation (38), m̅H̅₁ is the coefficient matrix representing the transfer of lining, X̅ is a state vector corresponding to both ends of segments and supports, m̅f̅ is the corresponding load matrix. The column of m̅H̅₁₁ corresponds to the state vector of the lining, odd lines write the transfer inside each segment, that is, Equation (29), and even lines write the transfer between the tail end of one segment and the starting end of the next segment, that is, Equation (35); the column of m̅H̅₂ corresponds to the state vector of the supports, since the equation of the supports has not been involved yet, therefore it is a 0 matrix, and the number of rows of the matrix is the same as m̅H̅₁₁, and the number of columns corresponds to the dimension of the state vector of the supports. Note: the segments are all divided in the circumferential direction, for example, from 30 degrees to 90 degrees, a segment contains all the rings, and the ring refers to the tunnel ring, and a ring further contains all the sections. In the state vector, the superscript in x̅ indicates the number of the segment section, starting from the lowest point (0 degrees) and numbering clockwise, and the subscript indicates the staring end (0) or the tail end (1). Because of the existence of the opening, the number of rows of the state vector (marked with *) of the segment section within the opening range will be less than that of other sections, therefore special treatment is needed in the transfer between the open segment and the unopened segment. Equation (40) shows that when the p^{th} segment is an open section, and only this section is an open section (when there are multiple sections within the opening angle, the dimensions of the transfer equation and the joint equation will be less, and this method is further applicable). When transferring from the tail end of the (p−1)^{th} segment to the starting end of the p^{th} segment, the joint matrix G̅^{p-1} is not a square matrix, but a matrix with fewer rows than columns. When transferring from the starting end to the tail end of the p^{th} segment, the dimension of the transfer matrix T̅^{p} is lower than that of the unopened segment. At the tail end of the p segment, the transfer direction on this joint is opposite to other joints, and it is transferred from the starting end of the (p−1)^{th} segment to the tail end of the p^{th} segment. The corresponding joint matrix G̅^{p} needs to be adjusted according to Equation (31), and it is further a matrix with fewer rows than columns. At the same time, it should be noted that the number of rows of the state vector of the supports (marked with #) is less than or equal to the number of rows of the state vector of the unopened segment (equal to if all calculation rings are provided with supports; less than if only part of the ring arrangement is provided with supports).

In the above step (5), by constructing a boundary condition matrix, the internal forces (Q, N, M) corresponding to the opening ring in the tail end of the previous section (p−1) and the starting end of the next section (p+1) of the opened section (p) are found, and they are set to 0, and the writing is as follows:

$${\overline{mH}}_{2} = ⋆ \overline{X} = 0 \qquad ( 44 )$$

The specific structural mode is illustrated as shown in Equation (45):

$$[ \begin{matrix}0 & 0 & 0 & 1 & 0 & 0 \\ 0 & 0 & 0 & 0 & 1 & 0 \\ 0 & 0 & 0 & 0 & 0 & 1\end{matrix} ] [ \begin{matrix}w \\ u \\ φ \\ Q \\ N \\ M\end{matrix} ] = [ \begin{matrix}0 \\ 0 \\ 0\end{matrix} ] \qquad ( 45 )$$

As shown in FIG. 6, in the above step (6), for Timoshenko straight beam:

$$Q = \int \int τ dA = {κ}_{s} {G}_{s} {A}_{s} ( \frac{d w}{d s} - φ ) \qquad ( 46 )$$

$$N = \int \int σ dA = {E}_{s} {A}_{s} \frac{d u}{d s} \qquad ( 47 )$$

$$M = - \int \int σ zdA = {E}_{s} {I}_{s} \frac{d φ}{d s} \qquad ( 48 )$$

$$\frac{d M}{d s} = - Q \qquad ( 49 )$$

where κₛ, Gₛ, Aₛ, Eₛ, and Iₛ represent the shear coefficient, shear modulus, cross-sectional area, elastic modulus and moment of inertia of the section of the supports, respectively. N, M, and Q are the axial force, bending moment and shear force of the section, respectively. w, u, and φ are the radial displacement, tangential displacement and section rotation angle of the lining, respectively. s is the coordinate on the s axis.

Equations (46)-(49) are arranged in a matrix form:

$$\frac{d x}{d s} = {A}_{s} x \qquad ( 50 )$$

$${A}_{s} = [ \begin{matrix}0 & 0 & 1 & \frac{1}{{κ}_{s} {G}_{s} {A}_{s}} & 0 & 0 \\ 0 & 0 & 0 & 0 & \frac{1}{{E}_{s} {A}_{s}} & 0 \\ 0 & 0 & 0 & 0 & 0 & \frac{1}{{E}_{s} {I}_{s}} \\ 0 & 0 & 0 & 0 & 0 & 0 \\ 0 & 0 & 0 & 0 & 0 & 0 \\ 0 & 0 & 0 & - 1 & 0 & 0\end{matrix} ] \qquad ( 51 )$$

$$where$$

$$x = {[ \begin{matrix}w & u & φ & Q & N & M\end{matrix} ]}^{T} \qquad ( 52 )$$

In order to facilitate the subsequent treatment of the balance equation at the joint between the supports and the segments, the state vector of the supports is further normalized in the same way:

$$s = R θ , w = R \overline{w} , u = R \overline{u} , φ = φ , Q = EAQ , N = E A \overline{N} , M = E A R \overline{M} \qquad ( 53 )$$

In equation (53), R, A are the curve radius and cross-sectional area in the lining, respectively. E is Young's modulus of the lining material. b is the width of segments, and h is the thickness of segments. All the physical quantities with crossed marks above are the physical quantities normalized from the original physical quantities, and θ is the physical quantity normalized from s.

The state equation of the segments can be obtained:

$$\frac{d \overline{x}}{d θ} = {\overline{A}}_{s} \overline{x} \qquad ( 54 )$$

$$where$$

$$\overline{x} = {[ \begin{matrix}\overline{w} & \overline{u} & \overline{φ} & \overline{Q} & \overline{N} & \overline{M}\end{matrix} ]}^{T} \qquad ( 55 )$$

$${\overline{A}}_{s} = [ \begin{matrix}0 & 0 & 1 & \frac{EA}{{κ}_{s} {G}_{s} {A}_{s}} & 0 & 0 \\ 0 & 0 & 0 & 0 & \frac{EA}{{E}_{s} {A}_{s}} & 0 \\ 0 & 0 & 0 & 0 & 0 & \frac{{EAR}^{2}}{{E}_{s} {I}_{s}} \\ 0 & 0 & 0 & 0 & 0 & 0 \\ 0 & 0 & 0 & 0 & 0 & 0 \\ 0 & 0 & 0 & - 1 & 0 & 0\end{matrix} ] \qquad ( 56 )$$

The standard solution of equation (54) is:

$$\overline{x} ( θ ) = {\overline{T}}_{s} ( θ - {θ}_{0} ) \overline{x} ( {θ}_{0} ) \qquad ( 57 )$$

Equation (57) is the transfer relation between the state vectors x̅(θ) and x̅(θ₀) of two points with the coordinates of θ and θ₀ on the supports. T̅ₛ(θ−θ₀) is the transfer matrix of the system, and its expression is as follows:

$${\overline{T}}_{s} ( θ - {θ}_{0} ) = {e}^{{\overline{A}}_{s} ( θ - {θ}_{0} )} \qquad ( 58 )$$

In equation (58), e is the natural constant.

According to Equation (57), the transfer equations of all supports are arranged in a matrix form:

$$\overline{m {H}_{3}} * \overline{X} = 0 \qquad ( 59 )$$

$$where$$

$$\overline{m {H}_{3}} = \begin{matrix}[ \overline{m {H}_{31}} & \overline{m {H}_{32}} ]\end{matrix} \qquad ( 60 )$$

$$\overline{m {H}_{31}} = 0 \qquad ( 61 )$$

$$\overline{m {H}_{32}} = [ \begin{matrix}- {\overline{T}}_{s}^{1} & I & 0 & 0 & … & … & … & 0 \\ 0 & 0 & - {\overline{T}}_{s}^{2} & I & ⋱ & ⋱ & ⋱ & ⋮ \\ ⋮ & … & … & … & ⋱ & ⋱ & ⋱ & 0 \\ 0 & … & … & … & … & 0 & - {\overline{T}}_{s}^{m} & I\end{matrix} ] \qquad ( 62 )$$

$$X = {[ \begin{matrix}{\overline{x}}_{0}^{1} & {\overline{x}}_{1}^{1} & … & {\overline{x}}_{1}^{p - 1} & {\overline{x}}_{0}^{* p} & {\overline{x}}_{1}^{* p} & {\overline{x}}_{0}^{p + 1} & … & {\overline{x}}_{0}^{n} & {\overline{x}}_{1}^{n} & {\overline{x}}_{0}^{\# n + 1} & {\overline{x}}_{1}^{\# n + 1} & … & … & {\overline{x}}_{0}^{\# n + m} & {\overline{x}}_{1}^{\# m + n}\end{matrix} ]}^{T} \qquad ( 63 )$$

In Equation (59), m̅H̅₃ is a coefficient matrix representing the support transfer, X̅ is the state vector corresponding to both ends of the segments and the supports. The column of m̅H̅₃₂ corresponds to the state vector of the supports, and each row is the transfer inside each support, that is, equation (57); the column of m̅H̅₃₁ corresponds to the state vector of the lining, and since it does not involve the equation of the lining at this time, it is a 0 matrix, and the number of rows of the matrix is the same as m̅H̅₃₂, and the number of columns corresponds to the dimension of the state vector of the lining.

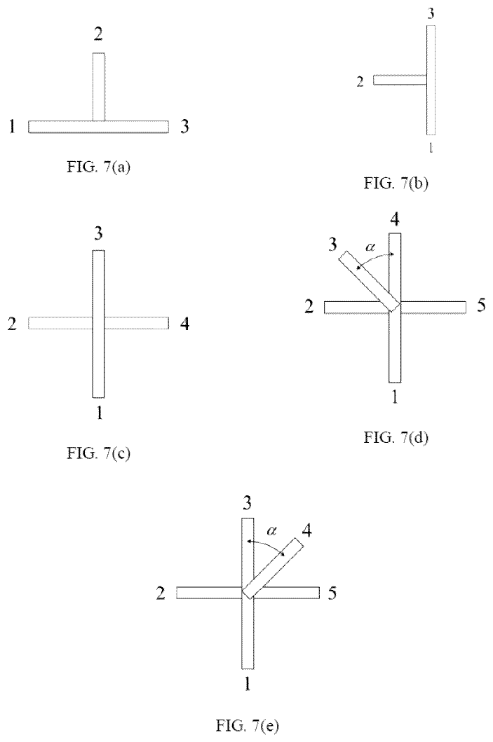

As shown in FIGS. 7(a)-7(e), some types of support intersection nodes that may appear in the above step (7) are listed (the node types that are not listed can be analyzed in a similar way). The temporary number of the supports at each type of support intersection node is shown in FIGS. 7(a)-7(e), with the left side of a horizontal support as the beginning and the right side as the tail end, the lower side of vertical support as the starting end and the upper side as the tail end, and the direction definition of a diagonal support is the same as that of the vertical support. The intersection node of each support will be analyzed, and according to the principle of same displacement at the node and balanced internal force, the balance equations of various nodes are listed.

For class-A nodes, there are three supports, involving six state vectors:

$$[ \begin{matrix}0 & {A}_{1} & {A}_{2} & 0 & {A}_{3} & 0 \\ 0 & {A}_{4} & 0 & 0 & {A}_{5} & 0\end{matrix} ] [ \begin{matrix}{\overline{x}}_{0}^{1} \\ {\overline{x}}_{1}^{1} \\ {\overline{x}}_{0}^{2} \\ {\overline{x}}_{1}^{2} \\ {\overline{x}}_{0}^{3} \\ {\overline{x}}_{1}^{3}\end{matrix} ] = 0 \qquad ( 64 )$$

$$where$$

$${A}_{1} = [ \begin{matrix}1 & 0 & 0 & 0 & 0 & 0 \\ 0 & 1 & 0 & 0 & 0 & 0 \\ 0 & 0 & 1 & 0 & 0 & 0 \\ 0 & 0 & 0 & 1 & 0 & 0 \\ 0 & 0 & 0 & 0 & 1 & 0 \\ 0 & 0 & 0 & 0 & 0 & 1\end{matrix} ] \qquad ( 65. a )$$

$${A}_{2} = [ \begin{matrix}0 & - 1 & 0 & 0 & 0 & 0 \\ 1 & 0 & 0 & 0 & 0 & 0 \\ 0 & 0 & - 1 & 0 & 0 & 0 \\ 0 & 0 & 0 & 0 & - 1 & 0 \\ 0 & 0 & 0 & 1 & 0 & 0 \\ 0 & 0 & 0 & 0 & 0 & - 1\end{matrix} ] \qquad ( 65. b )$$

$${A}_{3} = [ \begin{matrix}0 & 0 & 0 & 0 & 0 & 0 \\ 0 & 0 & 0 & 0 & 0 & 0 \\ 0 & 0 & 0 & 0 & 0 & 0 \\ 0 & 0 & 0 & - 1 & 0 & 0 \\ 0 & 0 & 0 & 0 & - 1 & 0 \\ 0 & 0 & 0 & 0 & 0 & - 1\end{matrix} ] \qquad ( 65. c )$$

$${A}_{4} = [ \begin{matrix}1 & 0 & 0 & 0 & 0 & 0 \\ 0 & 1 & 0 & 0 & 0 & 0 \\ 0 & 0 & 1 & 0 & 0 & 0 \\ 0 & 0 & 0 & 0 & 0 & 0 \\ 0 & 0 & 0 & 0 & 0 & 0 \\ 0 & 0 & 0 & 0 & 0 & 0\end{matrix} ] \qquad ( 65. d )$$

$${A}_{5} = [ \begin{matrix}- 1 & 0 & 0 & 0 & 0 & 0 \\ 0 & - 1 & 0 & 0 & 0 & 0 \\ 0 & 0 & - 1 & 0 & 0 & 0 \\ 0 & 0 & 0 & 0 & 0 & 0 \\ 0 & 0 & 0 & 0 & 0 & 0 \\ 0 & 0 & 0 & 0 & 0 & 0\end{matrix} ] \qquad ( 65. e )$$

For class-B nodes, there are three supports, involving six state vectors:

$$[ \begin{matrix}0 & {B}_{1} & 0 & {B}_{2} & {B}_{3} & 0 \\ 0 & {B}_{4} & 0 & 0 & {B}_{5} & 0\end{matrix} ] [ \begin{matrix}{\overline{x}}_{0}^{1} \\ {\overline{x}}_{1}^{1} \\ {\overline{x}}_{0}^{2} \\ {\overline{x}}_{1}^{2} \\ {\overline{x}}_{0}^{3} \\ {\overline{x}}_{1}^{3}\end{matrix} ] = 0 \qquad ( 66 )$$

$$where$$

$${B}_{1} = [ \begin{matrix}1 & 0 & 0 & 0 & 0 & 0 \\ 0 & 1 & 0 & 0 & 0 & 0 \\ 0 & 0 & 1 & 0 & 0 & 0 \\ 0 & 0 & 0 & 1 & 0 & 0 \\ 0 & 0 & 0 & 0 & 1 & 0 \\ 0 & 0 & 0 & 0 & 0 & 1\end{matrix} ] \qquad ( 67. a )$$

$${B}_{2} = [ \begin{matrix}0 & 1 & 0 & 0 & 0 & 0 \\ - 1 & 0 & 0 & 0 & 0 & 0 \\ 0 & 0 & - 1 & 0 & 0 & 0 \\ 0 & 0 & 0 & 0 & - 1 & 0 \\ 0 & 0 & 0 & 1 & 0 & 0 \\ 0 & 0 & 0 & 0 & 0 & - 1\end{matrix} ] \qquad ( 67. b )$$

$${B}_{3} = [ \begin{matrix}0 & 0 & 0 & 0 & 0 & 0 \\ 0 & 0 & 0 & 0 & 0 & 0 \\ 0 & 0 & 0 & 0 & 0 & 0 \\ 0 & 0 & 0 & - 1 & 0 & 0 \\ 0 & 0 & 0 & 0 & - 1 & 0 \\ 0 & 0 & 0 & 0 & 0 & - 1\end{matrix} ] \qquad ( 67. c )$$

$${B}_{4} = [ \begin{matrix}1 & 0 & 0 & 0 & 0 & 0 \\ 0 & 1 & 0 & 0 & 0 & 0 \\ 0 & 0 & 1 & 0 & 0 & 0 \\ 0 & 0 & 0 & 0 & 0 & 0 \\ 0 & 0 & 0 & 0 & 0 & 0 \\ 0 & 0 & 0 & 0 & 0 & 0\end{matrix} ] \qquad ( 67. d )$$

$${B}_{5} = [ \begin{matrix}- 1 & 0 & 0 & 0 & 0 & 0 \\ 0 & - 1 & 0 & 0 & 0 & 0 \\ 0 & 0 & - 1 & 0 & 0 & 0 \\ 0 & 0 & 0 & 0 & 0 & 0 \\ 0 & 0 & 0 & 0 & 0 & 0 \\ 0 & 0 & 0 & 0 & 0 & 0\end{matrix} ] \qquad ( 67. e )$$

For class-C nodes, there are four supports, involving eight state vectors:

$$[ \begin{matrix}0 & {C}_{1} & 0 & {C}_{2} & {C}_{3} & 0 & {C}_{4} & 0 \\ 0 & {C}_{5} & 0 & 0 & {C}_{6} & 0 & 0 & 0 \\ 0 & 0 & 0 & {C}_{7} & 0 & 0 & {C}_{8} & 0\end{matrix} ] [ \begin{matrix}{\overline{x}}_{0}^{1} \\ {\overline{x}}_{1}^{1} \\ {\overline{x}}_{0}^{2} \\ {\overline{x}}_{1}^{2} \\ {\overline{x}}_{0}^{3} \\ {\overline{x}}_{1}^{3} \\ {\overline{x}}_{0}^{4} \\ {\overline{x}}_{1}^{4}\end{matrix} ] = 0 \qquad ( 68 )$$

$$where$$

$${C}_{1} = [ \begin{matrix}1 & 0 & 0 & 0 & 0 & 0 \\ 0 & 1 & 0 & 0 & 0 & 0 \\ 0 & 0 & 1 & 0 & 0 & 0 \\ 0 & 0 & 0 & 1 & 0 & 0 \\ 0 & 0 & 0 & 0 & 1 & 0 \\ 0 & 0 & 0 & 0 & 0 & 1\end{matrix} ] \qquad ( 69. a )$$

$${C}_{2} = [ \begin{matrix}0 & 1 & 0 & 0 & 0 & 0 \\ - 1 & 0 & 0 & 0 & 0 & 0 \\ 0 & 0 & - 1 & 0 & 0 & 0 \\ 0 & 0 & 0 & 0 & - 1 & 0 \\ 0 & 0 & 0 & 1 & 0 & 0 \\ 0 & 0 & 0 & 0 & 0 & 1\end{matrix} ] \qquad ( 69. b )$$

$${C}_{3} = [ \begin{matrix}0 & 0 & 0 & 0 & 0 & 0 \\ 0 & 0 & 0 & 0 & 0 & 0 \\ 0 & 0 & 0 & 0 & 0 & 0 \\ 0 & 0 & 0 & - 1 & 0 & 0 \\ 0 & 0 & 0 & 0 & - 1 & 0 \\ 0 & 0 & 0 & 0 & 0 & - 1\end{matrix} ] \qquad ( 69. c )$$

$${C}_{4} = [ \begin{matrix}0 & 0 & 0 & 0 & 0 & 0 \\ 0 & 0 & 0 & 0 & 0 & 0 \\ 0 & 0 & 0 & 0 & 0 & 0 \\ 0 & 0 & 0 & 0 & 1 & 0 \\ 0 & 0 & 0 & - 1 & 0 & 0 \\ 0 & 0 & 0 & 0 & 0 & - 1\end{matrix} ] \qquad ( 69. d )$$

$${C}_{5} = {C}_{7} = [ \begin{matrix}1 & 0 & 0 & 0 & 0 & 0 \\ 0 & 1 & 0 & 0 & 0 & 0 \\ 0 & 0 & 1 & 0 & 0 & 0 \\ 0 & 0 & 0 & 0 & 0 & 0 \\ 0 & 0 & 0 & 0 & 0 & 0 \\ 0 & 0 & 0 & 0 & 0 & 0\end{matrix} ] \qquad ( 69. e )$$

$${C}_{6} = {C}_{8} = [ \begin{matrix}- 1 & 0 & 0 & 0 & 0 & 0 \\ 0 & - 1 & 0 & 0 & 0 & 0 \\ 0 & 0 & - 1 & 0 & 0 & 0 \\ 0 & 0 & 0 & 0 & 0 & 0 \\ 0 & 0 & 0 & 0 & 0 & 0 \\ 0 & 0 & 0 & 0 & 0 & 0\end{matrix} ] \qquad ( 69. f )$$

For class-D nodes, there are five supports, involving ten state vectors:

$$[ \begin{matrix}0 & {D}_{1} & 0 & {D}_{2} & {D}_{3} & 0 & {D}_{4} & 0 & {D}_{5} & 0 \\ 0 & {D}_{6} & 0 & 0 & 0 & 0 & {D}_{7} & 0 & 0 & 0 \\ 0 & 0 & 0 & {D}_{8} & 0 & 0 & 0 & 0 & {D}_{9} & 0 \\ 0 & {D}_{10} & 0 & 0 & {D}_{11} & 0 & 0 & 0 & 0 & 0\end{matrix} ] [ \begin{matrix}{\overline{x}}_{0}^{1} \\ {\overline{x}}_{1}^{1} \\ {\overline{x}}_{0}^{2} \\ {\overline{x}}_{1}^{2} \\ {\overline{x}}_{0}^{3} \\ {\overline{x}}_{1}^{3} \\ {\overline{x}}_{0}^{4} \\ {\overline{x}}_{1}^{4} \\ {\overline{x}}_{0}^{5} \\ {\overline{x}}_{1}^{5}\end{matrix} ] = 0 \qquad ( 70 )$$

$$where$$

$${D}_{1} = [ \begin{matrix}1 & 0 & 0 & 0 & 0 & 0 \\ 0 & 1 & 0 & 0 & 0 & 0 \\ 0 & 0 & 1 & 0 & 0 & 0 \\ 0 & 0 & 0 & 1 & 0 & 0 \\ 0 & 0 & 0 & 0 & 1 & 0 \\ 0 & 0 & 0 & 0 & 0 & 1\end{matrix} ] \qquad ( 71. a )$$

$${D}_{2} = [ \begin{matrix}0 & 1 & 0 & 0 & 0 & 0 \\ - 1 & 0 & 0 & 0 & 0 & 0 \\ 0 & 0 & - 1 & 0 & 0 & 0 \\ 0 & 0 & 0 & 0 & - 1 & 0 \\ 0 & 0 & 0 & 1 & 0 & 0 \\ 0 & 0 & 0 & 0 & 0 & 1\end{matrix} ] \qquad ( 71. b )$$

$${D}_{3} = [ \begin{matrix}0 & 0 & 0 & 0 & 0 & 0 \\ 0 & 0 & 0 & 0 & 0 & 0 \\ 0 & 0 & 0 & 0 & 0 & 0 \\ 0 & 0 & 0 & - cos α & - sin α & 0 \\ 0 & 0 & 0 & sin α & - cos α & 0 \\ 0 & 0 & 0 & 0 & 0 & - 1\end{matrix} ] \qquad ( 71. c )$$

$${D}_{4} = [ \begin{matrix}0 & 0 & 0 & 0 & 0 & 0 \\ 0 & 0 & 0 & 0 & 0 & 0 \\ 0 & 0 & 0 & 0 & 0 & 0 \\ 0 & 0 & 0 & - 1 & 0 & 0 \\ 0 & 0 & 0 & 0 & - 1 & 0 \\ 0 & 0 & 0 & 0 & 0 & - 1\end{matrix} ] \qquad ( 71. d )$$

$${D}_{5} = [ \begin{matrix}0 & 0 & 0 & 0 & 0 & 0 \\ 0 & 0 & 0 & 0 & 0 & 0 \\ 0 & 0 & 0 & 0 & 0 & 0 \\ 0 & 0 & 0 & 0 & 1 & 0 \\ 0 & 0 & 0 & - 1 & 0 & 0 \\ 0 & 0 & 0 & 0 & 0 & - 1\end{matrix} ] \qquad ( 71. e )$$

$${D}_{6} = {D}_{8} = [ \begin{matrix}- 1 & 0 & 0 & 0 & 0 & 0 \\ 0 & - 1 & 0 & 0 & 0 & 0 \\ 0 & 0 & - 1 & 0 & 0 & 0 \\ 0 & 0 & 0 & 0 & 0 & 0 \\ 0 & 0 & 0 & 0 & 0 & 0 \\ 0 & 0 & 0 & 0 & 0 & 0\end{matrix} ] \qquad ( 71. f )$$

$${D}_{7} = {D}_{9} = {D}_{10} = [ \begin{matrix}1 & 0 & 0 & 0 & 0 & 0 \\ 0 & 1 & 0 & 0 & 0 & 0 \\ 0 & 0 & 1 & 0 & 0 & 0 \\ 0 & 0 & 0 & 0 & 0 & 0 \\ 0 & 0 & 0 & 0 & 0 & 0 \\ 0 & 0 & 0 & 0 & 0 & 0\end{matrix} ] \qquad ( 71. g )$$

$${D}_{11} = [ \begin{matrix}- cos α & - sin α & 0 & 0 & 0 & 0 \\ sin α & - cos α & 0 & 0 & 0 & 0 \\ 0 & 0 & - 1 & 0 & 0 & 0 \\ 0 & 0 & 0 & 0 & 0 & 0 \\ 0 & 0 & 0 & 0 & 0 & 0 \\ 0 & 0 & 0 & 0 & 0 & 0\end{matrix} ] \qquad ( 71. h )$$

where α is the included angle between the inclined support and the vertical direction (as shown in FIG. 7(d)).

For class-E nodes, there are five supports, involving ten state vectors:

$$[ \begin{matrix}0 & {E}_{1} & 0 & {E}_{2} & {E}_{4} & 0 & {E}_{3} & 0 & {E}_{5} & 0 \\ 0 & {E}_{6} & 0 & 0 & {E}_{7} & 0 & 0 & 0 & 0 & 0 \\ 0 & 0 & 0 & {E}_{8} & 0 & 0 & 0 & 0 & {E}_{9} & 0 \\ 0 & {E}_{10} & 0 & 0 & 0 & 0 & {E}_{11} & 0 & 0 & 0\end{matrix} ] [ \begin{matrix}{\overline{x}}_{0}^{1} \\ {\overline{x}}_{1}^{1} \\ {\overline{x}}_{0}^{2} \\ {\overline{x}}_{1}^{2} \\ {\overline{x}}_{0}^{3} \\ {\overline{x}}_{1}^{3} \\ {\overline{x}}_{0}^{4} \\ {\overline{x}}_{1}^{4} \\ {\overline{x}}_{0}^{5} \\ {\overline{x}}_{1}^{5}\end{matrix} ] = 0 \qquad ( 72 )$$

$$where$$

$${E}_{1} = [ \begin{matrix}1 & 0 & 0 & 0 & 0 & 0 \\ 0 & 1 & 0 & 0 & 0 & 0 \\ 0 & 0 & 1 & 0 & 0 & 0 \\ 0 & 0 & 0 & 1 & 0 & 0 \\ 0 & 0 & 0 & 0 & 1 & 0 \\ 0 & 0 & 0 & 0 & 0 & 1\end{matrix} ] \qquad ( 73. a )$$

$${E}_{2} = [ \begin{matrix}0 & 1 & 0 & 0 & 0 & 0 \\ - 1 & 0 & 0 & 0 & 0 & 0 \\ 0 & 0 & - 1 & 0 & 0 & 0 \\ 0 & 0 & 0 & 0 & - 1 & 0 \\ 0 & 0 & 0 & 1 & 0 & 0 \\ 0 & 0 & 0 & 0 & 0 & 1\end{matrix} ] \qquad ( 73. b )$$

$${E}_{3} = [ \begin{matrix}0 & 0 & 0 & 0 & 0 & 0 \\ 0 & 0 & 0 & 0 & 0 & 0 \\ 0 & 0 & 0 & 0 & 0 & 0 \\ 0 & 0 & 0 & - cos α & sin α & 0 \\ 0 & 0 & 0 & - sin α & - cos α & 0 \\ 0 & 0 & 0 & 0 & 0 & - 1\end{matrix} ] \qquad ( 73. c )$$

$${E}_{4} = [ \begin{matrix}0 & 0 & 0 & 0 & 0 & 0 \\ 0 & 0 & 0 & 0 & 0 & 0 \\ 0 & 0 & 0 & 0 & 0 & 0 \\ 0 & 0 & 0 & - 1 & 0 & 0 \\ 0 & 0 & 0 & 0 & - 1 & 0 \\ 0 & 0 & 0 & 0 & 0 & - 1\end{matrix} ] \qquad ( 73. d )$$

$${E}_{5} = [ \begin{matrix}0 & 0 & 0 & 0 & 0 & 0 \\ 0 & 0 & 0 & 0 & 0 & 0 \\ 0 & 0 & 0 & 0 & 0 & 0 \\ 0 & 0 & 0 & 0 & 1 & 0 \\ 0 & 0 & 0 & - 1 & 0 & 0 \\ 0 & 0 & 0 & 0 & 0 & - 1\end{matrix} ] \qquad ( 73. e )$$

$${E}_{6} = {E}_{8} = [ \begin{matrix}- 1 & 0 & 0 & 0 & 0 & 0 \\ 0 & - 1 & 0 & 0 & 0 & 0 \\ 0 & 0 & - 1 & 0 & 0 & 0 \\ 0 & 0 & 0 & 0 & 0 & 0 \\ 0 & 0 & 0 & 0 & 0 & 0 \\ 0 & 0 & 0 & 0 & 0 & 0\end{matrix} ] \qquad ( 73. f )$$

$${E}_{7} = {E}_{9} = {E}_{10} = [ \begin{matrix}1 & 0 & 0 & 0 & 0 & 0 \\ 0 & 1 & 0 & 0 & 0 & 0 \\ 0 & 0 & 1 & 0 & 0 & 0 \\ 0 & 0 & 0 & 0 & 0 & 0 \\ 0 & 0 & 0 & 0 & 0 & 0 \\ 0 & 0 & 0 & 0 & 0 & 0\end{matrix} ] \qquad ( 73. g )$$

$${E}_{11} = [ \begin{matrix}- cos α & sin α & 0 & 0 & 0 & 0 \\ - sin α & - cos α & 0 & 0 & 0 & 0 \\ 0 & 0 & - 1 & 0 & 0 & 0 \\ 0 & 0 & 0 & 0 & 0 & 0 \\ 0 & 0 & 0 & 0 & 0 & 0 \\ 0 & 0 & 0 & 0 & 0 & 0\end{matrix} ] \qquad ( 73. h )$$

where α is the included angle between the inclined support and the vertical direction (as shown in FIG. 7(e)).

The above-mentioned balance equation describes the displacement and internal force relationship of various types of nodes at the intersection of the supports. After sorting out the above-mentioned balance equation, the following is obtained.

$$\overline{m {H}_{4}} * \overline{X} = 0 \qquad ( 74 )$$

### Note:

First, in the calculation, because one support state vector (for example x̅₀^{#n+1}) in the final state vector X̅ actually contains the state vectors of all supports in the same position in the transverse direction but in different rings in the longitudinal direction, it needs to be adjusted according to the number of rings in the support layout when forming the equation. Equation (75) takes the adjustment of A joint in the case of three rings in the support layout as an example, and other situations (including different numbers of rings in the support layout and different types of joints) are adjusted in the same way;

$$[ \begin{matrix}0 & {\overline{A}}_{1} & {\overline{A}}_{2} & 0 & {\overline{A}}_{3} & 0 \\ 0 & {\overline{A}}_{4} & 0 & 0 & {\overline{A}}_{5} & 0\end{matrix} ] [ \begin{matrix}{\overline{x}}_{0}^{1} \\ {\overline{x}}_{1}^{1} \\ {\overline{x}}_{0}^{2} \\ {\overline{x}}_{1}^{2} \\ {\overline{x}}_{0}^{3} \\ {\overline{x}}_{1}^{3}\end{matrix} ] = 0 \qquad ( 75 )$$

$$where$$

$${\overline{A}}_{1} = [ \begin{matrix}{A}_{1} & 0 & 0 \\ 0 & {A}_{1} & 0 \\ 0 & 0 & {A}_{1}\end{matrix} ] , … {\overline{A}}_{2} = [ \begin{matrix}{A}_{2} & 0 & 0 \\ 0 & {A}_{2} & 0 \\ 0 & 0 & {A}_{2}\end{matrix} ] \qquad ( 76 )$$

Secondly, in order to facilitate the derivation for each intersection node, the supports at the same node are temporarily numbered. These numbers are adjacent, but the state vectors of the supports at the same node may not be adjacent in the final state vector X̅, therefore it is necessary to adjust the position of each small matrix according to the specific situation when forming the equation.

Thirdly, the above five types of supporting intersection nodes cannot generalize all types of intersection nodes. When encountering other types of nodes, the balance equation can still be derived according to the above ideas and the principle of equal displacement and balanced internal force at the nodes.

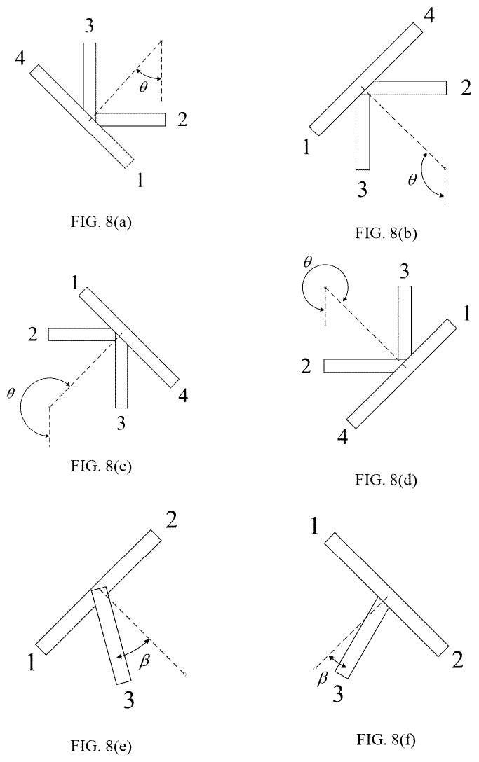

As shown in FIGS. 8(a)-8(e), some possible intersection node types of the supports and segments that may occur in the above step (8) are listed (the node types that are not listed can be analyzed by a similar method). The temporary number of the supports or segments at each type of intersection node of supports and segments is as shown in FIGS. 8(a)-8(e), the left side of the horizontal support being a starting end, the right side being a tail end, the lower side of vertical support being a starting end, the upper side being a tail end; the diagonal support is the same as the vertical support, and the starting end and the tail end are arranged clockwise in the segment section, respectively. The following is an analysis of each intersection node of the supports and segments. According to the principle of same displacement at the join and the balanced internal force, the balance equations of each node are listed:

For class-F nodes, there are four supports, involving eight state vectors:

$$[ \begin{matrix}0 & {F}_{1} & {F}_{2} & 0 & {F}_{3} & 0 & {F}_{4} & 0 \\ 0 & {F}_{5} & {F}_{6} & 0 & 0 & 0 & 0 & 0 \\ 0 & {F}_{7} & 0 & 0 & {F}_{8} & 0 & 0 & 0\end{matrix} ] [ \begin{matrix}{\overline{x}}_{0}^{1} \\ {\overline{x}}_{1}^{1} \\ {\overline{x}}_{0}^{2} \\ {\overline{x}}_{1}^{2} \\ {\overline{x}}_{0}^{3} \\ {\overline{x}}_{1}^{3} \\ {\overline{x}}_{0}^{4} \\ {\overline{x}}_{1}^{4}\end{matrix} ] = 0 \qquad ( 77 )$$

$$where$$

$${F}_{1} = [ \begin{matrix}1 & 0 & 0 & 0 & 0 & 0 \\ 0 & 1 & 0 & 0 & 0 & 0 \\ 0 & 0 & 1 & 0 & 0 & 0 \\ 0 & 0 & 0 & sin θ & cos θ & 0 \\ 0 & 0 & 0 & cos θ & - sin θ & 0 \\ 0 & 0 & 0 & 0 & 0 & 1\end{matrix} ] \qquad ( 78. a )$$

$${F}_{2} = [ \begin{matrix}0 & 0 & 0 & 0 & 0 & 0 \\ 0 & 0 & 0 & 0 & 0 & 0 \\ 0 & 0 & 0 & 0 & 0 & 0 \\ 0 & 0 & 0 & 0 & 1 & 0 \\ 0 & 0 & 0 & 1 & 0 & 0 \\ 0 & 0 & 0 & 0 & 0 & - 1\end{matrix} ] \qquad ( 78. b )$$

$${F}_{3} = [ \begin{matrix}0 & 0 & 0 & 0 & 0 & 0 \\ 0 & 0 & 0 & 0 & 0 & 0 \\ 0 & 0 & 0 & 0 & 0 & 0 \\ 0 & 0 & 0 & - 1 & 0 & 0 \\ 0 & 0 & 0 & 0 & 1 & 0 \\ 0 & 0 & 0 & 0 & 0 & - 1\end{matrix} ] \qquad ( 78. c )$$

$${F}_{4} = [ \begin{matrix}- 1 & 0 & 0 & 0 & 0 & 0 \\ 0 & - 1 & 0 & 0 & 0 & 0 \\ 0 & 0 & - 1 & 0 & 0 & 0 \\ 0 & 0 & 0 & - sin θ & - cos θ & 0 \\ 0 & 0 & 0 & - cos θ & sin θ & 0 \\ 0 & 0 & 0 & 0 & 0 & - 1\end{matrix} ] \qquad ( 78. d )$$

$${F}_{5} = [ \begin{matrix}sin θ & cos θ & 0 & 0 & 0 & 0 \\ - cos θ & sin θ & 0 & 0 & 0 & 0 \\ 0 & 0 & 1 & 0 & 0 & 0 \\ 0 & 0 & 0 & 0 & 0 & 0 \\ 0 & 0 & 0 & 0 & 0 & 0 \\ 0 & 0 & 0 & 0 & 0 & 0\end{matrix} ] \qquad ( 78. e )$$

$${F}_{6} = [ \begin{matrix}0 & 1 & 0 & 0 & 0 & 0 \\ - 1 & 0 & 0 & 0 & 0 & 0 \\ 0 & 0 & 1 & 0 & 0 & 0 \\ 0 & 0 & 0 & 0 & 0 & 0 \\ 0 & 0 & 0 & 0 & 0 & 0 \\ 0 & 0 & 0 & 0 & 0 & 0\end{matrix} ] \qquad ( 78. f )$$

$${F}_{7} = [ \begin{matrix}sin θ & cos θ & 0 & 0 & 0 & 0 \\ - cos θ & sin θ & 0 & 0 & 0 & 0 \\ 0 & 0 & 1 & 0 & 0 & 0 \\ 0 & 0 & 0 & 0 & 0 & 0 \\ 0 & 0 & 0 & 0 & 0 & 0 \\ 0 & 0 & 0 & 0 & 0 & 0\end{matrix} ] \qquad ( 78. g )$$

$${F}_{8} = [ \begin{matrix}- 1 & 0 & 0 & 0 & 0 & 0 \\ 0 & - 1 & 0 & 0 & 0 & 0 \\ 0 & 0 & - 1 & 0 & 0 & 0 \\ 0 & 0 & 0 & 0 & 0 & 0 \\ 0 & 0 & 0 & 0 & 0 & 0 \\ 0 & 0 & 0 & 0 & 0 & 0\end{matrix} ] \qquad ( 78. h )$$

where θ is the central angle corresponding to the intersecting position of the supports and the segments (as shown in FIG. 8(a)).

For class-G nodes, there are four supports, involving eight state vectors:

$$[ \begin{matrix}0 & {G}_{1} & {G}_{2} & 0 & 0 & {G}_{3} & {G}_{4} & 0 \\ 0 & {G}_{5} & {G}_{6} & 0 & 0 & 0 & 0 & 0 \\ 0 & {G}_{7} & 0 & 0 & 0 & {G}_{8} & 0 & 0\end{matrix} ] [ \begin{matrix}{\overline{x}}_{0}^{1} \\ {\overline{x}}_{1}^{1} \\ {\overline{x}}_{0}^{2} \\ {\overline{x}}_{1}^{2} \\ {\overline{x}}_{0}^{3} \\ {\overline{x}}_{1}^{3} \\ {\overline{x}}_{0}^{4} \\ {\overline{x}}_{1}^{4}\end{matrix} ] = 0 \qquad ( 79 )$$

$$where$$

$${G}_{1} = [ \begin{matrix}1 & 0 & 0 & 0 & 0 & 0 \\ 0 & 1 & 0 & 0 & 0 & 0 \\ 0 & 0 & 1 & 0 & 0 & 0 \\ 0 & 0 & 0 & sin θ & cos θ & 0 \\ 0 & 0 & 0 & cos θ & - sin θ & 0 \\ 0 & 0 & 0 & 0 & 0 & 1\end{matrix} ] \qquad ( 80. a )$$

$${G}_{2} = [ \begin{matrix}0 & 0 & 0 & 0 & 0 & 0 \\ 0 & 0 & 0 & 0 & 0 & 0 \\ 0 & 0 & 0 & 0 & 0 & 0 \\ 0 & 0 & 0 & 0 & 1 & 0 \\ 0 & 0 & 0 & 1 & 0 & 0 \\ 0 & 0 & 0 & 0 & 0 & - 1\end{matrix} ] \qquad ( 80. b )$$

$${G}_{3} = [ \begin{matrix}0 & 0 & 0 & 0 & 0 & 0 \\ 0 & 0 & 0 & 0 & 0 & 0 \\ 0 & 0 & 0 & 0 & 0 & 0 \\ 0 & 0 & 0 & - 1 & 0 & 0 \\ 0 & 0 & 0 & 0 & 1 & 0 \\ 0 & 0 & 0 & 0 & 0 & - 1\end{matrix} ] \qquad ( 80. c )$$

$${G}_{4} = [ \begin{matrix}- 1 & 0 & 0 & 0 & 0 & 0 \\ 0 & - 1 & 0 & 0 & 0 & 0 \\ 0 & 0 & - 1 & 0 & 0 & 0 \\ 0 & 0 & 0 & - sin θ & - cos θ & 0 \\ 0 & 0 & 0 & - cos θ & sin θ & 0 \\ 0 & 0 & 0 & 0 & 0 & - 1\end{matrix} ] \qquad ( 80. d )$$

$${G}_{5} = [ \begin{matrix}sin θ & cos θ & 0 & 0 & 0 & 0 \\ - cos θ & sin θ & 0 & 0 & 0 & 0 \\ 0 & 0 & 1 & 0 & 0 & 0 \\ 0 & 0 & 0 & 0 & 0 & 0 \\ 0 & 0 & 0 & 0 & 0 & 0 \\ 0 & 0 & 0 & 0 & 0 & 0\end{matrix} ] \qquad ( 80. e )$$

$${G}_{6} = [ \begin{matrix}0 & 1 & 0 & 0 & 0 & 0 \\ - 1 & 0 & 0 & 0 & 0 & 0 \\ 0 & 0 & 1 & 0 & 0 & 0 \\ 0 & 0 & 0 & 0 & 0 & 0 \\ 0 & 0 & 0 & 0 & 0 & 0 \\ 0 & 0 & 0 & 0 & 0 & 0\end{matrix} ] \qquad ( 80. f )$$

$${G}_{7} = [ \begin{matrix}sin θ & cos θ & 0 & 0 & 0 & 0 \\ - cos θ & sin θ & 0 & 0 & 0 & 0 \\ 0 & 0 & 1 & 0 & 0 & 0 \\ 0 & 0 & 0 & 0 & 0 & 0 \\ 0 & 0 & 0 & 0 & 0 & 0 \\ 0 & 0 & 0 & 0 & 0 & 0\end{matrix} ] \qquad ( 80. g )$$

$${G}_{8} = [ \begin{matrix}- 1 & 0 & 0 & 0 & 0 & 0 \\ 0 & - 1 & 0 & 0 & 0 & 0 \\ 0 & 0 & - 1 & 0 & 0 & 0 \\ 0 & 0 & 0 & 0 & 0 & 0 \\ 0 & 0 & 0 & 0 & 0 & 0 \\ 0 & 0 & 0 & 0 & 0 & 0\end{matrix} ] \qquad ( 80. h )$$

where θ is the central angle corresponding to the intersecting position of the supports and the segments (as shown in FIG. 8(b)).

For class-H nodes, there are four supports, involving eight state vectors:

$$[ \begin{matrix}0 & {H}_{1} & 0 & {H}_{2} & 0 & {H}_{3} & {H}_{4} & 0 \\ 0 & {H}_{5} & 0 & {H}_{6} & 0 & 0 & 0 & 0 \\ 0 & {H}_{7} & 0 & 0 & 0 & {H}_{8} & 0 & 0\end{matrix} ] [ \begin{matrix}{\overline{x}}_{0}^{1} \\ {\overline{x}}_{1}^{1} \\ {\overline{x}}_{0}^{2} \\ {\overline{x}}_{1}^{2} \\ {\overline{x}}_{0}^{3} \\ {\overline{x}}_{1}^{3} \\ {\overline{x}}_{0}^{4} \\ {\overline{x}}_{1}^{4}\end{matrix} ] = 0 \qquad ( 81 )$$

$$where : {H}_{1} = [ \begin{matrix}1 & 0 & 0 & 0 & 0 & 0 \\ 0 & 1 & 0 & 0 & 0 & 0 \\ 0 & 0 & 1 & 0 & 0 & 0 \\ 0 & 0 & 0 & sin θ & cos θ & 0 \\ 0 & 0 & 0 & cos θ & - sin θ & 0 \\ 0 & 0 & 0 & 0 & 0 & 1\end{matrix} ] \qquad ( 82. a )$$

$${H}_{2} = [ \begin{matrix}0 & 0 & 0 & 0 & 0 & 0 \\ 0 & 0 & 0 & 0 & 0 & 0 \\ 0 & 0 & 0 & 0 & 0 & 0 \\ 0 & 0 & 0 & 0 & - 1 & 0 \\ 0 & 0 & 0 & - 1 & 0 & 0 \\ 0 & 0 & 0 & 0 & 0 & 1\end{matrix} ] \qquad ( 82. b )$$

$${H}_{3} = [ \begin{matrix}0 & 0 & 0 & 0 & 0 & 0 \\ 0 & 0 & 0 & 0 & 0 & 0 \\ 0 & 0 & 0 & 0 & 0 & 0 \\ 0 & 0 & 0 & 1 & 0 & 0 \\ 0 & 0 & 0 & 0 & - 1 & 0 \\ 0 & 0 & 0 & 0 & 0 & 1\end{matrix} ] \qquad ( 82. c )$$

$${H}_{4} = [ \begin{matrix}- 1 & 0 & 0 & 0 & 0 & 0 \\ 0 & - 1 & 0 & 0 & 0 & 0 \\ 0 & 0 & - 1 & 0 & 0 & 0 \\ 0 & 0 & 0 & - sin θ & - cos θ & 0 \\ 0 & 0 & 0 & - cos θ & sin θ & 0 \\ 0 & 0 & 0 & 0 & 0 & - 1\end{matrix} ] \qquad ( 82. d )$$

$${H}_{5} = [ \begin{matrix}sin θ & cos θ & 0 & 0 & 0 & 0 \\ - cos θ & sin θ & 0 & 0 & 0 & 0 \\ 0 & 0 & 1 & 0 & 0 & 0 \\ 0 & 0 & 0 & 0 & 0 & 0 \\ 0 & 0 & 0 & 0 & 0 & 0 \\ 0 & 0 & 0 & 0 & 0 & 0\end{matrix} ] \qquad ( 82. e )$$

$${H}_{6} = [ \begin{matrix}0 & 1 & 0 & 0 & 0 & 0 \\ - 1 & 0 & 0 & 0 & 0 & 0 \\ 0 & 0 & - 1 & 0 & 0 & 0 \\ 0 & 0 & 0 & 0 & 0 & 0 \\ 0 & 0 & 0 & 0 & 0 & 0 \\ 0 & 0 & 0 & 0 & 0 & 0\end{matrix} ] \qquad ( 82. f )$$

$${H}_{7} = [ \begin{matrix}sin θ & cos θ & 0 & 0 & 0 & 0 \\ - cos θ & sin θ & 0 & 0 & 0 & 0 \\ 0 & 0 & 1 & 0 & 0 & 0 \\ 0 & 0 & 0 & 0 & 0 & 0 \\ 0 & 0 & 0 & 0 & 0 & 0 \\ 0 & 0 & 0 & 0 & 0 & 0\end{matrix} ] \qquad ( 82. g )$$

$${H}_{8} = [ \begin{matrix}- 1 & 0 & 0 & 0 & 0 & 0 \\ 0 & - 1 & 0 & 0 & 0 & 0 \\ 0 & 0 & - 1 & 0 & 0 & 0 \\ 0 & 0 & 0 & 0 & 0 & 0 \\ 0 & 0 & 0 & 0 & 0 & 0 \\ 0 & 0 & 0 & 0 & 0 & 0\end{matrix} ] \qquad ( 82. h )$$

where θ is the central angle corresponding to the intersection position of the supports and the segments (as shown in FIG. 8(c)).

For class-I nodes, there are four supports, involving eight state vectors:

$$[ \begin{matrix}0 & {I}_{1} & 0 & {I}_{2} & {I}_{3} & 0 & {I}_{4} & 0 \\ 0 & {I}_{5} & 0 & {I}_{6} & 0 & 0 & 0 & 0 \\ 0 & {I}_{7} & 0 & 0 & {I}_{8} & 0 & 0 & 0\end{matrix} ] [ \begin{matrix}{\overline{x}}_{0}^{1} \\ {\overline{x}}_{1}^{1} \\ {\overline{x}}_{0}^{2} \\ {\overline{x}}_{1}^{2} \\ {\overline{x}}_{0}^{3} \\ {\overline{x}}_{1}^{3} \\ {\overline{x}}_{0}^{4} \\ {\overline{x}}_{1}^{4}\end{matrix} ] = 0 \qquad ( 83 )$$

$$where$$

$${I}_{1} = [ \begin{matrix}1 & 0 & 0 & 0 & 0 & 0 \\ 0 & 1 & 0 & 0 & 0 & 0 \\ 0 & 0 & 1 & 0 & 0 & 0 \\ 0 & 0 & 0 & sin θ & cos θ & 0 \\ 0 & 0 & 0 & cos θ & - sin θ & 0 \\ 0 & 0 & 0 & 0 & 0 & 1\end{matrix} ] \qquad ( 84. a )$$

$${I}_{2} = [ \begin{matrix}0 & 0 & 0 & 0 & 0 & 0 \\ 0 & 0 & 0 & 0 & 0 & 0 \\ 0 & 0 & 0 & 0 & 0 & 0 \\ 0 & 0 & 0 & 0 & - 1 & 0 \\ 0 & 0 & 0 & - 1 & 0 & 0 \\ 0 & 0 & 0 & 0 & 0 & 1\end{matrix} ] \qquad ( 84. b )$$

$${I}_{3} = [ \begin{matrix}0 & 0 & 0 & 0 & 0 & 0 \\ 0 & 0 & 0 & 0 & 0 & 0 \\ 0 & 0 & 0 & 0 & 0 & 0 \\ 0 & 0 & 0 & - 1 & 0 & 0 \\ 0 & 0 & 0 & 0 & 1 & 0 \\ 0 & 0 & 0 & 0 & 0 & - 1\end{matrix} ] \qquad ( 84. c )$$

$${I}_{4} = [ \begin{matrix}- 1 & 0 & 0 & 0 & 0 & 0 \\ 0 & - 1 & 0 & 0 & 0 & 0 \\ 0 & 0 & - 1 & 0 & 0 & 0 \\ 0 & 0 & 0 & - sin θ & - cos θ & 0 \\ 0 & 0 & 0 & - cos θ & sin θ & 0 \\ 0 & 0 & 0 & 0 & 0 & - 1\end{matrix} ] \qquad ( 84. d )$$

$${I}_{5} = [ \begin{matrix}sin θ & cos θ & 0 & 0 & 0 & 0 \\ - cos θ & sin θ & 0 & 0 & 0 & 0 \\ 0 & 0 & 1 & 0 & 0 & 0 \\ 0 & 0 & 0 & 0 & 0 & 0 \\ 0 & 0 & 0 & 0 & 0 & 0 \\ 0 & 0 & 0 & 0 & 0 & 0\end{matrix} ] \qquad ( 84. e )$$

$${I}_{6} = [ \begin{matrix}0 & 1 & 0 & 0 & 0 & 0 \\ - 1 & 0 & 0 & 0 & 0 & 0 \\ 0 & 0 & - 1 & 0 & 0 & 0 \\ 0 & 0 & 0 & 0 & 0 & 0 \\ 0 & 0 & 0 & 0 & 0 & 0 \\ 0 & 0 & 0 & 0 & 0 & 0\end{matrix} ] \qquad ( 84. f )$$

$${I}_{7} = [ \begin{matrix}sin θ & cos θ & 0 & 0 & 0 & 0 \\ - cos θ & sin θ & 0 & 0 & 0 & 0 \\ 0 & 0 & 1 & 0 & 0 & 0 \\ 0 & 0 & 0 & 0 & 0 & 0 \\ 0 & 0 & 0 & 0 & 0 & 0 \\ 0 & 0 & 0 & 0 & 0 & 0\end{matrix} ] \qquad ( 84. g )$$

$${I}_{8} = [ \begin{matrix}- 1 & 0 & 0 & 0 & 0 & 0 \\ 0 & - 1 & 0 & 0 & 0 & 0 \\ 0 & 0 & - 1 & 0 & 0 & 0 \\ 0 & 0 & 0 & 0 & 0 & 0 \\ 0 & 0 & 0 & 0 & 0 & 0 \\ 0 & 0 & 0 & 0 & 0 & 0\end{matrix} ] \qquad ( 84. h )$$

where θ is the central angle corresponding to the intersection position of the supports and the segments (as shown in FIG. 8(d)).

For class-J nodes, there are three supports, involving six state vectors:

$$[ \begin{matrix}0 & {J}_{1} & 0 & {J}_{2} & {J}_{3} & 0 \\ 0 & {J}_{4} & 0 & {J}_{5} & 0 & 0\end{matrix} ] [ \begin{matrix}{\overline{x}}_{0}^{1} \\ {\overline{x}}_{1}^{1} \\ {\overline{x}}_{0}^{2} \\ {\overline{x}}_{1}^{2} \\ {\overline{x}}_{0}^{3} \\ {\overline{x}}_{1}^{3}\end{matrix} ] = 0 \qquad ( 85 )$$

$$where$$

$${J}_{1} = [ \begin{matrix}1 & 0 & 0 & 0 & 0 & 0 \\ 0 & 1 & 0 & 0 & 0 & 0 \\ 0 & 0 & 1 & 0 & 0 & 0 \\ 0 & 0 & 0 & 1 & 0 & 0 \\ 0 & 0 & 0 & 0 & 1 & 0 \\ 0 & 0 & 0 & 0 & 0 & 1\end{matrix} ] \qquad ( 86. a )$$

$${J}_{2} = [ \begin{matrix}0 & 0 & 0 & 0 & 0 & 0 \\ 0 & 0 & 0 & 0 & 0 & 0 \\ 0 & 0 & 0 & 0 & 0 & 0 \\ 0 & 0 & 0 & sin β & cos β & 0 \\ 0 & 0 & 0 & cos β & sin β & 0 \\ 0 & 0 & 0 & 0 & 0 & 1\end{matrix} ] \qquad ( 86. b )$$

$${J}_{3} = [ \begin{matrix}- 1 & 0 & 0 & 0 & 0 & 0 \\ 0 & - 1 & 0 & 0 & 0 & 0 \\ 0 & 0 & - 1 & 0 & 0 & 0 \\ 0 & 0 & 0 & - 1 & 0 & 0 \\ 0 & 0 & 0 & 0 & - 1 & 0 \\ 0 & 0 & 0 & 0 & 0 & - 1\end{matrix} ] \qquad ( 86. c )$$

$${J}_{4} = [ \begin{matrix}1 & 0 & 0 & 0 & 0 & 0 \\ 0 & 1 & 0 & 0 & 0 & 0 \\ 0 & 0 & 1 & 0 & 0 & 0 \\ 0 & 0 & 0 & 0 & 0 & 0 \\ 0 & 0 & 0 & 0 & 0 & 0 \\ 0 & 0 & 0 & 0 & 0 & 0\end{matrix} ] \qquad ( 86. d )$$

$${J}_{5} = [ \begin{matrix}- sin β & - cos β & 0 & 0 & 0 & 0 \\ cos β & - sin β & 0 & 0 & 0 & 0 \\ 0 & 0 & - 1 & 0 & 0 & 0 \\ 0 & 0 & 0 & 0 & 0 & 0 \\ 0 & 0 & 0 & 0 & 0 & 0 \\ 0 & 0 & 0 & 0 & 0 & 0\end{matrix} ] \qquad ( 86. e )$$

where β is the included angle between the diagonal support and the radius connecting the intersection point and the center of the circle (as shown in FIG. 8(e)).

For class-K nodes, there are three supports, involving six state vectors:

$$[ \begin{matrix}0 & {K}_{1} & 0 & {K}_{2} & {K}_{3} & 0 \\ 0 & {K}_{4} & 0 & {K}_{5} & 0 & 0\end{matrix} ] [ \begin{matrix}{\overline{x}}_{0}^{1} \\ {\overline{x}}_{1}^{1} \\ {\overline{x}}_{0}^{2} \\ {\overline{x}}_{1}^{2} \\ {\overline{x}}_{0}^{3} \\ {\overline{x}}_{1}^{3}\end{matrix} ] = 0 \qquad ( 87 )$$

$$where$$

$${K}_{1} = [ \begin{matrix}1 & 0 & 0 & 0 & 0 & 0 \\ 0 & 1 & 0 & 0 & 0 & 0 \\ 0 & 0 & 1 & 0 & 0 & 0 \\ 0 & 0 & 0 & 1 & 0 & 0 \\ 0 & 0 & 0 & 0 & 1 & 0 \\ 0 & 0 & 0 & 0 & 0 & 1\end{matrix} ] \qquad ( 88. a )$$

$${K}_{2} = [ \begin{matrix}0 & 0 & 0 & 0 & 0 & 0 \\ 0 & 0 & 0 & 0 & 0 & 0 \\ 0 & 0 & 0 & 0 & 0 & 0 \\ 0 & 0 & 0 & - sin β & cos β & 0 \\ 0 & 0 & 0 & - cos β & - sin β & 0 \\ 0 & 0 & 0 & 0 & 0 & 1\end{matrix} ] \qquad ( 88. b )$$

$${K}_{3} = [ \begin{matrix}- 1 & 0 & 0 & 0 & 0 & 0 \\ 0 & - 1 & 0 & 0 & 0 & 0 \\ 0 & 0 & - 1 & 0 & 0 & 0 \\ 0 & 0 & 0 & - 1 & 0 & 0 \\ 0 & 0 & 0 & 0 & - 1 & 0 \\ 0 & 0 & 0 & 0 & 0 & - 1\end{matrix} ] \qquad ( 88. c )$$

$${K}_{4} = [ \begin{matrix}1 & 0 & 0 & 0 & 0 & 0 \\ 0 & 1 & 0 & 0 & 0 & 0 \\ 0 & 0 & 1 & 0 & 0 & 0 \\ 0 & 0 & 0 & 0 & 0 & 0 \\ 0 & 0 & 0 & 0 & 0 & 0 \\ 0 & 0 & 0 & 0 & 0 & 0\end{matrix} ] \qquad ( 88. d )$$

$${K}_{5} = [ \begin{matrix}sin β & - cos β & 0 & 0 & 0 & 0 \\ cos β & sin β & 0 & 0 & 0 & 0 \\ 0 & 0 & - 1 & 0 & 0 & 0 \\ 0 & 0 & 0 & 0 & 0 & 0 \\ 0 & 0 & 0 & 0 & 0 & 0 \\ 0 & 0 & 0 & 0 & 0 & 0\end{matrix} ] \qquad ( 88. e )$$

where β is the included angle between the diagonal support and the radius connecting the intersection point and the center of the circle (as shown in FIG. 8(f)).

The above-mentioned balance equation describes the displacement and internal force relationship of various types of nodes at the joints between the supports and the segments. After sorting out the above-mentioned balance equation, the following is obtained:

$$\overline{m {H}_{5}} * \overline{X} = 0 \qquad ( 89 )$$

### Note:

First, in the calculation, because one support state vector (for example x̅₀^{#n+1}) in the final state vector x̅ actually contains state vectors of all the supports in the same position in the transverse direction but in different rings in the longitudinal direction, it is necessary to adjust according to the number of rings arranged at the intersection nodes of the supports and the segments when forming the equation of the intersection of the supports and the segments, and the adjustment method is the same as that at the intersection of the supports.

Secondly, in the case that only a part of the lining rings are supported, because the dimensions of the state vectors of the supports and the segments are different in the final state vector (for example, there are five rings of linings, but only three of them are supported, and in the final state vector, the dimension of the segment state vector is 5*6=30, while the dimension of the support state vector is 3*6=18), it is necessary to make adjustments when forming the equation. The above two adjustments take the K-joint as an example.

$$[ \begin{matrix}0 & {\overline{K}}_{1} & 0 & {\overline{K}}_{2} & {\overline{K}}_{3} & 0 \\ 0 & {\overline{K}}_{4} & 0 & {\overline{K}}_{5} & 0 & 0\end{matrix} ] [ \begin{matrix}{\overline{x}}_{0}^{1} \\ {\overline{x}}_{1}^{1} \\ {\overline{x}}_{0}^{\# 2} \\ {\overline{x}}_{1}^{\# 2} \\ {\overline{x}}_{0}^{3} \\ {\overline{x}}_{1}^{3}\end{matrix} ] = 0 \qquad ( 90 )$$

$$where$$

$${\overline{K}}_{1} = [ \begin{matrix}0 & {K}_{1} & 0 & 0 & 0 \\ 0 & 0 & {K}_{1} & 0 & 0 \\ 0 & 0 & 0 & {K}_{1} & 0\end{matrix} ] , {\overline{K}}_{3} = [ \begin{matrix}0 & {K}_{3} & 0 & 0 & 0 \\ 0 & 0 & {K}_{3} & 0 & 0 \\ 0 & 0 & 0 & {K}_{3} & 0\end{matrix} ] , {\overline{K}}_{4} = [ \begin{matrix}0 & {K}_{4} & 0 & 0 & 0 \\ 0 & 0 & {K}_{4} & 0 & 0 \\ 0 & 0 & 0 & {K}_{4} & 0\end{matrix} ] , {\overline{K}}_{2} = [ \begin{matrix}{K}_{2} & 0 & 0 \\ 0 & {K}_{2} & 0 \\ 0 & 0 & {K}_{2}\end{matrix} ] , {\overline{K}}_{5} = [ \begin{matrix}{K}_{5} & 0 & 0 \\ 0 & {K}_{5} & 0 \\ 0 & 0 & {K}_{5}\end{matrix} ] \qquad ( 91 )$$

Thirdly, in order to facilitate the derivation for each intersection node, the supports at the same node are temporarily numbered. These numbers are adjacent, but the state vectors of the supports at the same node may not be adjacent in the final state vector X̅, therefore it is necessary to adjust the position of each small matrix according to the specific situation when forming the equation.

Fourthly, the above-mentioned six types of intersection nodes between supports and segments cannot generalize all types of intersection nodes between supports and segments, and when encountering other types of nodes, the balance equation can still be deduced according to the above ideas and the principle of equal displacement and internal force balance at the joint.

In the above step (9), the equations obtained in the above step are integrated to obtain the final matrix equation, as shown in Equation (92). The final matrix equation of the integral ring is solved to obtain the state vector including radial displacements, tangential displacements, section rotation angles, shear forces, axial forces and bending moments of the section at the starting end and the tail end of all segments and supports after normalization.

Then, the state vector including radial displacements, tangential displacements, section rotation angles, shear forces, axial forces and bending moments of any section of all segments and the supports after normalization is obtained according to the transfer equation inside the segments obtained in step (2) and the transfer equation inside the supports obtained in step (6), and reverse normalization is performed on the obtained state vector including radial displacements, tangential displacements, section rotation angles, shear forces, axial forces and bending moments of each section after normalization to obtain an opening response of the shield tunnel considering staggered joint assembly and reinforcement support.

$$\overline{mH} ⋆ \overline{X} = \overline{mf} \qquad ( 92 )$$

$$where$$

$$\overline{mH} = [ \begin{matrix}{\overline{mH}}_{1} \\ {\overline{mH}}_{2} \\ {\overline{mH}}_{3} \\ {\overline{mH}}_{4} \\ {\overline{mH}}_{5}\end{matrix} ]$$

$$\overline{mf} = [ \begin{matrix}{\overline{mf}}_{1} \\ 0 \\ 0 \\ 0 \\ 0\end{matrix} ] \qquad ( 93. b )$$

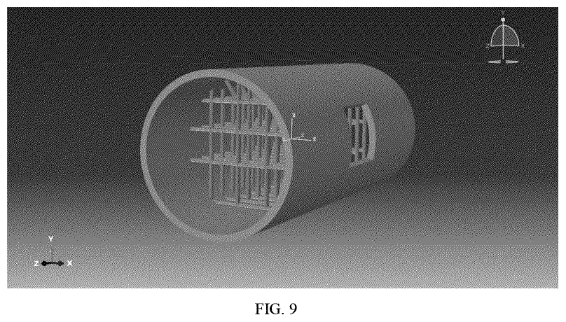

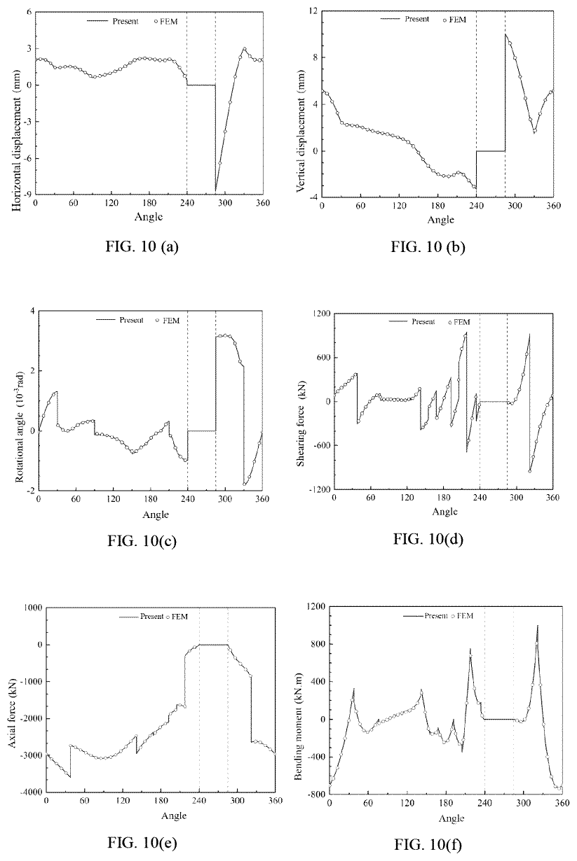

The soil spring stiffness coefficient (k_{z}, kₛ), the load form (q_{z}, qₛ), the longitudinal joint stiffness (kᵥ, kᵤ, k_{φ}) and the inter-ring joint stiffness (k_{fz}, k_{fs}) in each ring are not assumed in the above derivation process, and the soil spring stiffness of each segment ring, the inter-ring joint stiffness of each joint and the load on the tunnel are assigned with values, respectively, according to the actual needs to take into account the inhomogeneity of strata along the longitudinal direction of the tunnel, the difference of joint stiffness values and the influence of arbitrary load forms. At the same time, the above derivation process does not assume the form of supports, the number of rings and the position of supports. By changing the relevant parameters of support layout, the opening response and support response of the shield tunnel under different support design solutions can be calculated to optimize the support design. As shown in FIGS. 10(a)-10(f), the calculation result of the opening response of the shield tunnel with supports considering staggered joints is given, and the calculation result of the analytical method of the present disclosure is compared with the numerical calculation result of ABAQUS (the numerical model is shown in FIG. 9). It can be seen that the results of the two are in good agreement. This proves the effectiveness of the method of the present disclosure.

TABLE 1
Calculation Parameters of Present Method

| Parameter | Parameter | | Value of |
|---|---|---|---|
| category | name | Unit | Parameter |
| Geometric | Rᵢ (inner | m | 6.2 |
| parameter | diameter) | | |
| of shield | Rₒ (outside | m | 6.8 |
| tunnel | diameter) | | |
| | b (width) | m | 2 |
| | h (wall | m | 0.6 |
| | thickness) | | |
| | l (calculated | m | 30 |
| | length) | | |
| | Joint angle | ° | [0, 30, 90, 150, 210, |
| | | | 270, 330, 360] |
| | Staggered angle | ° | 20 |
| Opening | Perforated ring | | [7, 8, 9] |
| attribute | Opening angle | ° | [240, 285] |
| Lining | E_{c} (elastic | kPa | 3.0 × 10⁷ |
| material | modulus) | | |
| parameters | v_{c} (Poisson's | | 0.2 |
| | ratio) | | |
| Soil spring | k_{z} | kPa | 8830 |
| stiffness | kₛ | kPa | 2940 |
| parameter | | | |
| Longitudinal | k_{w} (radial | kN/m² | 1.0 × 10⁷ |
| joint | spring) | | |
| stiffness | kᵤ (axial spring) | kN/m² | 1.0 × 10¹⁰ |
| parameter | k_{φ}(rotational | kN · m/ | 5400 |
| | angle spring) | rad | |
| Inter-ring | k_{fz} | kN/m³ | 1.71 × 10⁵ |
| joint | k_{fs} | kN/m³ | 2.54 × 10⁵ |
| stiffness | | | |
| parameter | | | |
| Load | q₁ | kN/m | 330.35 |
| parameter | q₂ | kN/m | 357.83 |
| (Refer to | q₃ | kN/m | 189.095 |
| FIG. 2) | q₄ | kN/m | 137.965 |
| | q₅ | kN/m | 0 |
| Support | Support angle | | [38, 76, 101, 126, 142, |
| parameter | | | 155, 168, 192, 205, |
| (refer to | | | 218, 234, 322] |
| FIGS. 5(a)- | Support ring | | [4, 5, 6, 7, 8, 9, |
| 5(b) for | number | | 10, 11, 12] |
| layout) | Section area | m² | [2.39 × 10⁻², |
| | | | 2.39 × 10⁻²] |
| | Moment of | m⁴ | [4.32 × 10⁻⁴, |
| | inertia | | 4.32 × 10⁻⁴] |
| | Shear | | [0.53, 0.53] |
| | coefficient of | | |
| | section | | |
| | Modulus of | kPa | 206000000 |
| | elasticity | | |
| | Poisson's ratio | | 0.2 |

TABLE 2
Calculation parameters of finite element model

| Parameter | Parameter | | Value of |
|---|---|---|---|
| category | name | Unit | Parameter |
| Geometric | Rᵢ (inner | m | 6.2 |
| parameter | diameter) | | |
| of shield | Rₒ (outside | m | 6.8 |
| tunnel | diameter) | | |
| | b (width) | m | 2 |
| | h (wall | m | 0.6 |
| | thickness) | | |
| | l (calculated | m | 30 |
| | length) | | |
| | Joint angle | ° | [0, 30, 90, 150, 210, |
| | | | 270, 330, 360] |
| | Staggered | ° | 20 |
| | angle | | [7, 8, 9] |
| Opening | Perforated | | |
| attribute | ring | | |
| | Opening | ° | [240, 285] |
| | angle | | |
| Lining | E_{c} (elastic | kPa | 3.0 × 10⁷ |
| material | modulus) | | |
| parameters | v_{c} (Poisson's | | 0.2 |
| | ratio) | | |
| Soil spring | k_{z} | kPa | 2003.5 |
| stiffness | kₛ | kPa | 667.8 |
| parameter | | | |
| Longitudinal | k_{w} (radial | kN/m² | 1.0 × 10⁷ |
| joint | spring) | | |
| stiffness | kᵤ (axial | kN/m² | 1.0 × 10¹⁰ |
| parameter | spring) | | |
| | k_{φ}(rotational | kN · m/ | 5400 |
| | angle spring) | rad | |
| Inter-ring | k_{fz} | kN/m³ | 1.164 × 10⁴ |
| joint | k_{fs} | kN/m³ | 1.729 × 10⁴ |
| stiffness | | | |
| parameter | | | |
| Load | q₁ | kN/m | 660.7 |
| parameter | q₂ | kN/m | 715.66 |
| (Refer to | q₃ | kN/m | 378.19 |
| FIG. 2) | q₄ | kN/m | 275.93 |
| | q₅ | kN/m | 0 |
| Support | Support angle | | [38, 76, 101, 126, 142, |
| parameter | | | 155, 168, 192, 205, |
| (refer to | | | 218, 234, 322] |
| FIGS. 5(a)- | Support ring | | [4, 5, 6, 7, 8, 9, |
| 5(b) for | number | | 10, 11, 12] |
| layout) | Section area | m² | [2.39 × 10⁻², |
| | | | 2.39 × 10⁻²] |
| | Moment of | m⁴ | [4.32 × 10⁻⁴, |
| | inertia | | 4.32 × 10⁻⁴] |
| | Shear | | [0.53, 0.53] |
| | coefficient of | | |
| | section | | |
| | Modulus of | kPa | 206000000 |
| | elasticity | | |
| | Poisson's ratio | | 0.2 |

Note:
1. The difference between the parameters of the soil spring and the inter-ring spring in the finite element model in Table 2 and the corresponding parameters in Table 1 is because the springs in the analysis are uniformly distributed, while the springs in the finite element model can only be point springs, therefore it needs to be converted.
2. The load parameter of the finite element model in Table 2 being twice that of the corresponding parameter in Table 1 is because the finite element is applied with a linear load, and the influence of the width needs to be considered manually. Therefore, it is multiplied by the width b of the tunnel.

Under the action of stratum load, the opening position of shield tunnel has a large displacement due to the weakening of stiffness, and the influence of the opening will be transferred to the adjacent ring through the inter-ring shear spring. At the same time, the opening section is similar to a cantilever, and the end point of the cantilever is the longitudinal joint in the ring closest to the opening position. The length of the “cantilever” will directly affect the mechanical response caused by the opening. Support can effectively compensate the loss of segment stiffness caused by segment opening. Therefore, in the method provided by the present disclosure, considering the mechanical response modeling of assembled shield tunnel under the opening condition, it is necessary to start from the segment body model, the force transfer between the longitudinal joints in the ring and the anti-shearing joints between the rings, and the interaction between soil and the tunnel, and consider the mechanical coupling behavior of the supports and the segments, and finally obtain the method for calculating an opening response of the shield tunnel with supports.

The method for calculating an opening response of the shield tunnel with supports provided by the present disclosure is an analytical calculation method based on the beam-spring model and the state-space method, and fully considers the assembling effect and the supporting effect of the shield tunnel. Compared with the results of ABAQUS finite element model and the results of the present disclosure, the effectiveness of this method is proved. This method is convenient to calculate the mechanical response of the lining and supports after opening of the shield tunnel with staggered joint assembly and reinforced by supports, which avoids the problems of complex finite element modeling and difficult modification, and provides a basis for the optimization of supports and segments under opening conditions.

The state-space method takes the force and displacement of energy duality as the solution quantities at the same time, which avoids the problem of determining the undetermined coefficient when solving the higher-order equation, and can conveniently obtain the physical quantity transfer relationship between tunnel sections under any load. In this method, that state-space method is introduced, and the calculation method of the opening response and support response of the shield tunnel considering staggered joint assembly and reinforcement support is given. Compared with the results of finite element model, the correctness of the solution in this paper is verified. The method in this paper can conveniently calculate the opening response and support response of the shield tunnel with staggered joint assembly and reinforced supports under the conditions of arbitrary diameter, arbitrary geological conditions, arbitrary joint conditions, arbitrary opening angle and opening ring number, arbitrary support arrangement form (referring to the arrangement form of the supports in a single ring) and arbitrary number of rings in the support arrangement (referring to the number of rings in which supports are arranged, and the total number of rings in which supports are arranged), which provides a convenient and fast calculation method for the mechanical response calculation of the shield tunnel under opening condition, and provides a new possibility for the design and optimization of lining segments and supports.

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The above is only the preferred embodiment of the present disclosure, and the protection scope of the present disclosure is not limited to the above embodiments, and all technical solutions under the idea of the present disclosure belong to the protection scope of the present disclosure. It should be pointed out that for those skilled in the art, a number of improvements and retouching without departing from the principles of the present disclosure should further be regarded as the protection scope of the present disclosure.

1. A method for calculating an opening response of a shield tunnel with supports, wherein the shield tunnel with supports comprises the shield tunnel and the supports arranged in the shield tunnel, the shield tunnel comprises segments, circumferential joints between adjacent rings, and longitudinal joints spliced and assembled to each other, and the shield tunnel is provided with a rectangular opening, wherein the method comprises following steps:
step (1) treating each of the segments as a curved beam with a rectangular section, wherein a curve radius in the curved beam of the segments is recorded as R, and a coordinate axis z-s is established along a radial direction and a tangential direction, with a z direction being the radial direction, a s direction being the tangential direction, a radial displacement is recorded as w, a tangential displacement is recorded as u, a rotation angle of a segment cross-section is recorded as p, a shear force, an axial force and a bending moment on the segment cross-section is recorded as Q, N and M, respectively; and
taking each of the segments as an analysis object, and establishing a segment mechanical model of the shield tunnel;
step (2) considering a shear deformation of the segment cross-section under the segment mechanical model of the shield tunnel, simulating, by a Timoshenko beam theory, a mechanical behavior of a lining, and normalizing a mechanical behavior of an inter-ring seam between rings by a radial shear spring coefficient k_{fz} and a tangential shear spring coefficient k_{fs} to obtain a normalized radial shear spring coefficient k̅_{fz} and a normalized tangential shear spring coefficient k̅_{fs};
setting a radial soil spring coefficient k_{z} and a tangential soil spring coefficient kₛ, simulating, by a Winkler soil spring, the interaction between the shield tunnel and a stratum, and performing normalization to obtain a normalized radial soil spring coefficient k̅_{z} and a normalized tangential soil spring coefficient k̅ₛ;
obtaining a radial load q_{z} and a tangential load qₛ borne by the segments, and performing normalization to obtain a normalized radial load q̅_{zi} and a normalized tangential load q̅ₛᵢ;
establishing a segment state equation; and
solving a standard solution according to the segment state equation to obtain a transfer equation and a transfer matrix inside the segments;
step (3) setting a joint radial spring coefficient k_{w}, a joint tangential spring coefficient kᵤ and a joint rotational spring coefficient k_{φ}, and simulating a mechanical behavior of the longitudinal joints of the shield tunnel connected to each other along a circumferential direction of the segments using a radial, tangential and rotational three-directional joint spring;
considering staggered joint assembly of the segments of the shield tunnel, following a principle of a continuous internal force and a discontinuous displacement where at least one of the longitudinal joints connected to each other along the circumferential direction of the segments exists; setting virtual joints no joint exists, following a principle of both continuous internal force and displacement, establishing a longitudinal joint equation of the shield tunnel connected along the circumferential direction of the segments, transforming the longitudinal joint equation to obtain a transfer equation between a tail end of one segment and a starting end of a next segment, and arranging the transfer equation into a form of a matrix equation to obtain a joint transfer matrix;
step (4) dividing the longitudinal joints connected to each other along the circumferential direction of the segments and connection positions between the supports and the segments of the shield tunnel into multiple segment sections, alternately using the transfer equation inside the segments obtained in the step (2) and the transfer equation between the tail end of one segment and the starting end of the next segment obtained in the step (3) along the circumferential direction of the shield tunnel according to a sequence of the segment sections, until the circumferential direction turns back to a circle, that is, establishing an initial integral ring matrix equation, wherein a left side of the initial integral ring matrix equation is an initial coefficient matrix right multiplied by a state vector comprising radial displacements, tangential displacements, section rotation angles, shear forces, axial forces and bending moments of the sections at the tail end and the starting end of all segments after normalization, a right side of the initial integral ring matrix equation is a vector comprising a load integral vector and a zero vector, the initial integral ring matrix equation comprises a transfer inside the segments and a joint transfer caused by the longitudinal joints, excluding a transfer at the connection positions between the supports and the segments;
step (5) a length of the rectangular opening along an axial direction of the shield tunnel being an integer multiple of a width of the segments, and using a free boundary condition for simulation at the rectangular opening, with the internal force being 0, that is, a supplementary condition, constructing a corresponding supplementary coefficient matrix, screening out the internal force corresponding to an opening position in the state vector through the supplementary coefficient matrix, the internal force at the opening position being a corresponding zero vector to obtain a supplementary opening equation;
step (6) taking each of the supports as a straight beam, considering a shear deformation of a cross section of each of the supports under a support mechanical model, and stimulating a mechanical behavior of the supports by the Timoshenko beam theory; and
establishing a coordinate axis z-s along the straight beam, with a s direction being the axial direction and a z direction being perpendicular to the axial direction; denoting a displacement perpendicular to the axial direction as w and an axial displacement as u, considering that the section rotation angle of the segments is denoted as φ, and the shear force, the axial force and the bending moment of the sections are denoted as Q, N and M, respectively, taking each of the supports as an analysis object, establishing the support mechanical model to obtain a state equation of each of the supports, solving the state equation to obtain a transfer equation inside the supports, and integrating the transfer equation in multiple supports to obtain a total transfer equation inside the supports;
step (7) segmenting from an intersection node, calculating and obtaining a balance equation of a support node at the intersection node during calculation, as rigid connection, according to a principle of same displacement and internal force balance;
step (8) calculating the connection positions between the supports and the segments as rigid connection, and obtaining a balance equation at the intersection of the supports and the segments according to the principle of same displacement and internal force balance; and
step (9) integrating the initial integral ring matrix equation obtained in the step (4) with the supplementary opening equation obtained in the step (5), the transfer equation inside the supports obtained in the step (6), the balance equation of the support node obtained in the step (7) and the balance equation at the intersection of the supports and the segments obtained in the step (8) to form a final integral ring matrix equation, and solving a final matrix equation to obtain the state vector comprising radial displacements, tangential displacements, section rotation angles, shear forces, axial forces and bending moments of the sections at the tail end and the starting end of all segments and the supports after normalization; and
obtaining a state vector comprising radial displacements, tangential displacements, section rotation angles, shear forces, axial forces and bending moments of any section of all segments and the supports after normalization according to the transfer equation inside the segments obtained in the step (2) and the transfer equation inside the supports obtained in the step (6), performing reverse normalization on the obtained state vector comprising the radial displacements, the tangential displacements, the section rotation angles, the shear forces, the axial forces and the bending moments of each section after normalization to obtain the opening response of the shield tunnel, obtaining optimized structures, positions and quantities of all the segments and the supports, determining support and reinforcement structures of the shield tunnel and manufacturing all the segments and the supports based on the opening response of the shield tunnel, and constructing the shield tunnel with the segments and the supports based on the optimized structures, positions, quantities and the support and reinforcement structures.

2. The method according to claim 1, wherein in the step (2), said establishing a segment state equation; and said solving a standard solution according to the segment state equation to obtain a transfer equation and a transfer matrix inside the segments comprise:
the segment state equation is:
$$\frac{d \overline{x}}{d θ} = \overline{A} \overline{x} + \overline{q} \qquad ( 22 )$$
where x̅ represents a state vector comprising radial displacements, tangential displacements, section rotation angles, shear forces, axial forces and bending moments after normalization, θ represents a normalized tangential coordinate, Ā represents a normalized system matrix, comprising section information, material information, shear spring information between rings and soil spring information of the segments, and q represents a normalized load vector;
a standard solution of the segment state equation is the transfer equation inside the segments as follows:
$$\overline{x} ( θ ) = \overline{T} ( θ - {θ}_{0} ) \overline{x} ( {θ}_{0} ) + \overline{f} ( θ - {θ}_{0} ) \qquad ( 29 )$$
where x̅ represents a state vector comprising radial displacements, tangential displacements, section rotation angles, shear forces, axial forces and bending moments after normalization on the sections with a normalized tangential coordinate of θ, and x̅(θ₀) represents a state vector comprising radial displacements, tangential displacements, section rotation angles, shear forces, axial forces and bending moments after normalization on the sections with a normalized tangential coordinate of θ₀;
a matrix T̅(θ−θ₀) represents a normalized transfer matrix inside the segments from θ₀ to θ, and a matrix f̅(θ−θ₀) represents a normalized load integral vector from θ₀ to θ:
$$\overline{T} ( θ - {θ}_{0} ) = {e}^{\overline{A} ( θ - {θ}_{0} )} , \overline{f} ( θ - {θ}_{0} ) = {\int }_{{θ}_{0}}^{θ} {e}^{\overline{A} ( θ - ξ )} \overline{q} ( ξ ) d ξ \qquad ( 30 )$$
where e represents the natural constant, ξ represents an integral variable, and Ā represents a normalized system matrix.

3. The method according to claim 1, wherein in the step (3), the transfer equation between the tail end of one segment and the starting end of the next segment is:
$${\overline{x}}_{0}^{j + 1} = {\overline{G}}^{j} {\overline{x}}_{1}^{j} \qquad ( 35 )$$
where x̅₀^{j+1} represents a normalized state vector at the starting end of a (j+1)^{th} segment, x̅₁^{j} represents a normalized state vector at the tail end of a j^{th} segment, and G̅^{j} represents a normalized joint transfer matrix of a j^{th} joint.

4. The method according to claim 1, wherein in the step (4), the initial integral ring matrix equation is:
$${\overline{mH}}_{1} ⋆ \overline{X} = {\overline{mf}}_{1} \qquad ( 38 )$$
where m̅H̅₁ represents an initial coefficient matrix obtained by alternately integrating the transfer equation inside the segments obtained in the step (2) and the transfer equation between the tail end of one segment and the starting end of the next segment obtained in the step (3), X̅ represents a state vector comprising radial displacements, tangential displacements, section rotation angles, shear forces, axial forces and bending moments of the sections at the tail end and the starting end of all segments and the supports after normalization, and m̅f̅₁ represents a vector comprising a load integral vector and a zero vector.

5. The method according to claim 1, wherein in the step (5), the supplementary opening equation is:
$${\overline{mH}}_{2}^{*} \overline{X} = 0 \qquad ( 44 )$$
where m̅H̅₂ represents a supplementary coefficient matrix, X̅ represents a state vector comprising radial displacements, tangential displacements, section rotation angles, shear forces, axial forces and bending moments of the sections at the tail end and the starting end of all segments and the supports after normalization; a number of columns of the supplementary coefficient matrix m̅H̅₂ is the same as that of the initial coefficient matrix m̅H̅₁, equal to a number of rows of the state vector; and a number of rows of the supplementary coefficient matrix m̅H̅₂ is determined by a ratio of a length of the opening along the axial direction of the shield tunnel to a width of the segments, and a number of rows of the zero vector on the right side of the supplementary opening equation is equal to that of the supplementary coefficient matrix m̅H̅₂.

6. The method according claim 1, wherein in the step (6), the support state equation is:
$$\frac{d \overline{x}}{d θ} = {\overline{A}}_{s} \overline{x} \qquad ( 50 )$$
where x̅ represents a state vector comprising radial displacements, tangential displacements, section rotation angles, shear forces, axial forces and bending moments after normalization, θ represents a normalized tangential coordinate, Āₛ represents a normalized system matrix, comprising section information, material information of each of the supports;
the standard solution to the state equation is the transfer equation:
$$\overline{x} ( θ ) = {\overline{T}}_{s} ( θ - {θ}_{0} ) \overline{x} ( {θ}_{0} ) \qquad ( 57 )$$
where x̅ represents a state vector comprising radial displacements, tangential displacements, section rotation angles, shear forces, axial forces and bending moments after normalization on the sections with a normalized tangential coordinate of θ, and x̅(θ₀) represents a state vector comprising radial displacements, tangential displacements, section rotation angles, shear forces, axial forces and bending moments after normalization on the sections with a normalized tangential coordinate of θ₀; and
a matrix T̅ₛ(θ−θ₀) is the normalized transfer matrix from θ₀ to 0:
$${\overline{T}}_{s} ( θ - {θ}_{0} ) = {e}^{{\overline{A}}_{s} ( θ - {θ}_{0} )} \qquad ( 58 )$$
where e represents the natural constant.

7. The method according to claim 1, wherein in the step (6), the total transfer equation inside the supports is:
$${\overline{m H}}_{3} ⋆ \overline{X} = 0 \qquad ( 59 )$$
where m̅H̅₃ represents a support coefficient matrix, and X̅ represents a state vector comprising radial displacements, tangential displacements, section rotation angles, shear forces, axial forces and bending moments of the sections at the tail end and the starting end of all segments and the supports after normalization.

8. The method according to claim 1, wherein in the step (7), the balance equation of the support node is:
$${\overline{mH}}_{4} ⋆ \overline{X} = 0 \qquad ( 74 )$$
where m̅H̅₄ represents a node balance matrix, and X̅ represents a state vector comprising radial displacements, tangential displacements, section rotation angles, shear forces, axial forces and bending moments of the sections at the tail end and the starting end of all segments and the supports after normalization.

9. The method according to claim 1, wherein in the step (8), the balance equation at the intersection of the supports and the segments is:
$${\overline{mH}}_{5} ⋆ \overline{X} = 0 \qquad ( 89 )$$
where m̅H̅₅ represents a connection balance matrix, and X̅ represents a state vector comprising radial displacements, tangential displacements, section rotation angles, shear forces, axial forces and bending moments of the sections at the tail end and the starting end of all segments and the supports after normalization.

10. The method according to claim 1, wherein in the step (9), the final matrix equation is:
$$\overline{mH} ⋆ \overline{X} = \overline{mf} \qquad ( 92 )$$
$$where$$
$$\overline{mH} = [ \begin{matrix}{\overline{mH}}_{1} \\ {\overline{mH}}_{2} \\ {\overline{mH}}_{3} \\ {\overline{mH}}_{4} \\ {\overline{mH}}_{5}\end{matrix} ] \qquad ( 93. a )$$
$$\overline{mf} = [ \begin{matrix}{\overline{mf}}_{1} \\ 0 \\ 0 \\ 0 \\ 0\end{matrix} ] . \qquad ( 93. b )$$
